(19) United States
(12) Patent Application Publication
(10) Pub. No.: US 2003/0034999 A1
(43) Pub. Date: Feb. 20, 2003

(54) Enhancing interactive presentations

(75) Inventors: James Earl Martin Coughlin III, Bedford, NH (US); Avik Mukhopadhyay, New York City, NY (US); Michael Joel Newman, Coral Gables, FL (US)

Correspondence Address: HALE AND DORR, LLP, 60 STATE STREET, BOSTON, MA, 02109

(73) Assignee: MindSpeak, LLC, Bedford, NH

(21) Appl. No.: 10/158,403

(22) Filed: May 30, 2002

Related U.S. Application Data
(60) Provisional application No. 60/294,746, filed on May 31, 2001.

(51) Int. Cl. G09G 5/00

(52) U.S. Cl. 345/738

(57) ABSTRACT

Methods and systems are provided for use in enhancing interactive presentations. Access is gained to a computer-based presentation that is presentable by conventional desktop presentation software, and a feature is added to the computer-based presentation. An aspect of the feature may be presentable by the conventional desktop presentation software. Using Internet-standard protocols, a real-time directive is issued to a playback device based on the feature and a response to the directive is received. A real time analysis of results of issuing the directive may be provided based at least in part on the response.

### CROSS-REFERENCE TO RELATED APPLICATIONS

This application claims the benefit of U.S. Provisional Application Serial No. 60/294,746 entitled “A METHOD AND SYSTEM FOR ENHANCING ACADEMIC PRODUCTIVITY AND INTERACTIVITY WHILE DEVELOPING REAL-TIME STUDENT AND CLASSWIDE PROFILES”, filed on May 31, 2001, which is incorporated herein by reference.

### FIELD OF THE INVENTION

The present invention is directed to enhancing interactive presentations.

### BACKGROUND OF THE INVENTION

Although there have been a number of technological developments in the area of systems for making presentations to audiences such as overhead projectors, large screen televisions, and electronic overhead projection systems for displaying computer data and video tape presentation systems, there have not been similar advances in the way that the audience can communicate with the speaker. Developments in this area have been limited to methods by which selected members of the audience can communicate with the speaker and the remainder of the audience by way of voice audio systems. Systems such as these include roving microphones which provide participants in a meeting with increased and improved speech intelligibility through sound amplification and distribution. This type of system, representative of similar units, does not allow for the collection of data or information from a large number of audience members.

Another type of system that is used to obtain information from an audience is the commonly known 800 or 900 telephone polling system. Typically, this system consists of a broadcast medium such as radio or television posing a question to its audience and then requesting a response by having members of the audience call one of several numbers associated with a proposed response. Although this type of system is capable of providing large amounts of data, it does not have any selectivity with regard to the audience participating in the survey and, indeed, is susceptible to single individuals calling in a multiple number of times. Further, this type of system is not practical for the typical presentation made to an audience in the usual business or educational setting.

Previous attempts to measure the effectiveness of a presentation were to gather information from participants and concentrated on written, after the event, questionnaires which can be impractical in at least some circumstances. The use of questionnaires during a presentation improves the response quality, but can require excessive effort to obtain, analyze, and distribute the results. The written response approach also does not provide immediate responses from the audience, nor does it provide the ability to present the results immediately.

Known in the art are hard-wired, one direction, response devices which allow an audience to provide a “yes” or “no” response to a question.

Other systems, employing personal computers in a local area network, have been used to record findings for group presentations, but have required a system that was uniquely designed for the event and the location, and substantial expertise to preplan and apply the collected data.

Microsoft Visual Basic for Applications (VBA) is a development technology for rapidly customizing rich-client desktop packaged applications and integrating them with existing data and systems. VBA provides a set of programming tools based on the Microsoft Visual Basic development system, which developers can use to build upon the capabilities of packaged applications. VBA is a component of Microsoft Office (such as Microsoft Office XP) including Microsoft PowerPoint and Microsoft Excel.

### SUMMARY OF THE INVENTION

Methods and systems are provided for use in enhancing interactive presentations. In one or more aspects of the invention, access is gained to a computer-based presentation that is presentable by conventional desktop presentation software, and a feature is added to the computer-based presentation. An aspect of the feature may be presentable by the conventional desktop presentation software. Using Internet-standard protocols, a real-time directive is issued to a playback device based on the feature and a response to the directive is received. A real time analysis of results of issuing the directive may be provided based at least in part on the response.

A presentation solution can be provided that has high ease of use and that makes efficient use of existing application software such as the Microsoft Office application suite, presentation software such as Microsoft PowerPoint, and/or spreadsheet application software such as Microsoft Excel. Users can take advantage of their familiarity with PowerPoint and Excel, which can make the presentation solution readily accessible and acceptable to the users, and can help expedite user training on the presentation solution.

Scripting and automation support built into existing software such as Microsoft Office can be used together with Internet protocol technology to achieve substantial value-adding synergy gains. Low development time can be achieved and improvements in new releases of existing software such as Microsoft Office can be preserved and exploited.

A presentation solution can be provided in which a distributed system can provide benefits at low cost to multiple information processing devices even if only one of the devices (e.g., the presenter's computer) runs existing application software such as Microsoft Office, and other devices (e.g., audience members' notebook or handheld computers) run other software such as conventional Web browser software.

Server software can be provided through which other software, such as various pieces of client software, can communicate to provide a presentation solution, and the server software can run without necessarily relying on, and requiring maintenance of, a central server. Communication among computing devices in a presentation solution can be based on Internet protocol standards such as Hypertext Transfer Protocol (HTTP), allowing the central server, if any, to be physically located almost anywhere. Ease of implementation and maintenance of a presentation solution can be provided by using other conventional (possibly no-license) technology, such as a cross-platform, Java-based server such as Apache Tomcat Application Server from Apache Software Foundation. A presentation solution can provided that is sufficiently flexible to run on one or more of multiple application servers that are available, including Oracle Corporation's 9i platform, with little or no modification.

Other advantages and features will become apparent from the following description, including the drawings, and from the claims.

### BRIEF DESCRIPTION OF THE DRAWINGS

FIGS. 1-4 are block diagrams of example presentation system components.

FIGS. 5-21, 23-33 are illustrations of example presentation system software output.

FIG. 21 is an illustration of example data used in a presentation system.

FIGS. 34-41 are illustrations of example software components of a presentation system.

### DETAILED DESCRIPTION

A method and apparatus for enhancing interactive presentations is described. In the following detailed description, numerous specific details are set forth regarding the process and the environment in which the process may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Also, the same references numerals are used in the drawings and in the description to refer to the same elements.

A presentation solution is provided that, among other things, seeks to increase interaction and real-time assessment of audience members by allowing the presenter and audience members to engage in enhanced communication, e.g., by using a wired or wireless network and mobile computing devices, such as handheld computers or laptop computers. The presentation solution may be applied in any presentation environment, including academic and/or corporate environments, to provide efficient communication between presenters and audience members that may be in different physical locations. As described below, presenters can also quantify aspects of the interactive environment.

In an example embodiment, the presentation solution makes use of and works together with existing application software such as Microsoft Office, particularly Microsoft PowerPoint and Excel, and allows audience members to log in to a computing device such as a PDA or a laptop computer at the beginning of a session, anonymously answer questions posed by the presenter, pose their own questions for increased session discussion, and provide real-time feedback on their comprehension of the material being presented, without necessarily interrupting the flow of the presentation. In the example embodiment, post-presentation, the presenter can data-mine data and analyze audience feedback, e.g., to develop a portfolio of responses for each individual audience member, to effectively track the member's progress throughout either individual or multiple sessions (e.g., in the academic market, a semester), and/or to derive information that is helpful for identifying areas of weakness and offering personalized help to each individual, without excessively burdening the user (presenter) since the underlying calculations are automated in the solution. The example embodiment also supplies user-friendly functionality and one-click integration.

In the example embodiment, which is directed to an environment in which a professor serves as presenter and students serve as audience members, the presenter is able to obtain real-time responses in efforts to:

Determine if students have read and comprehended the text assigned before class.

Assess the penetration level of a concept.

Determine the exact point at which the class is unable to comprehend the presented material, or whether the class as a whole finds the material too simplistic.

Direct the class in a manner that the students find interesting.

Survey the class to demonstrate a concept.

Obtain anonymous and therefore candid feedback from the students.

Software in the example embodiment operates in two modes with respect to the students. In the first mode, the data is attributed to individual students, and in the second mode the attribution is to a unique identifier (not the student's name), thereby making the responses anonymous.

The example embodiment's software also allows the professor or an aide to perform data analysis after the class is over, to help assess:

The attendance performance of a student.

The percentage of time a student correctly or incorrectly answers a question.

The percentage of time the student responds and the accuracy of that response.

The level of concept comprehension by the class.

The type of questions a student has difficulty understanding.

In addition, the software allows the professor to use the questions that were posed by students during the class, by, for example:

Electronically mailing all or selected questions posed by students to aides for discussion in a smaller setting.

Responding to individual questions.

Posting the questions from previous classes for classroom discussion.

Monitoring the quality of questions from students thereby making easier the process by which they can identify the needs of individual students.

Estimating the degree to which a student is able to think unconventionally and want to understand the material being presented.

The example embodiment's software also allows the professor to use the feedback logged against individual slides in the presentation during the class to:

Refine lecture material to make it easier to understand.

Obtain feedback and refine the method of delivery to become a better presenter.

Furthermore, software is implemented in a modular approach in the example embodiment, which allows data aggregation at a higher level using a standardized set of questions. For example, if there are two classrooms using the software, by using a standardized set of questions, professors and aides and others can compare individual students' and classes' responses to particular questions so that the progress of different classes can be monitored and compared. Administrators or funding agencies can issue the same set of standardized questions at the beginning and end of a term and make judgments based on perceived performance increases. Using the software across classes, professor performance evaluations can also be carried out, e.g., to help new teachers find a “natural fit” during in-class training periods to help determine where they can add the most value and where they can build on their natural teaching styles. Trend analysis can also be carried out using data from multiple time periods to monitor overall performance.

In another typical embodiment, the presentation solution can be used in corporate applications to produce a more productive and dynamic corporate environment utilizing real-time audience feedback and post session data analysis tools. For example, the software can be used in efforts to:

Engage the audience in the meeting, giving each participant a voice, to help increase attentiveness.

Reduce meeting time—key decisions can be made known immediately among groups, divisions, or stockholders through the immediate tabulation of votes.

Increase participant commitment to outcomes—the solution can improve direct involvement in the decision-making process by increasing loyalty to results.

Encourage honest feedback, helping to produce an accurate representation of an individual's opinion and knowledge.

Determine whether audience members (for example, in training sessions) have read and comprehended the material assigned in preparation for the session.

Assess the penetration level of a concept immediately after it is conveyed.

Determine the exact point at which the session is unable to comprehend the presented material, or whether the audience as a whole finds the material too simplistic.

Survey the audience to demonstrate a concept.

Obtain anonymous and candid feedback from the audience members (the anonymity can be particularly helpful in the corporate market, as persons may be more likely to be more candid in their responses where there is a reduced chance of being penalized for speaking their minds).

Determine the correct and incorrect response percentages.

Determine attendance levels.

In addition, in a typical corporate application, presenters can:

Individually answer responses.

Post the questions from previous sessions for group discussion.

Monitor the quality of questions from audience members (e.g., trainees) thereby making easier the process by which they can identify the needs of individual members.

Help determine the degree to which an audience member is able to think unconventionally and want to understand the material being presented.

Refine their lecture material to make it easier to understand.

Obtain feedback and refine their method of concept delivery to become a better presenter.

In the corporate application, data aggregation by the software adds value in the solution. For example, to analyze the impact of a new technology in a brokerage firm, branch offices nationally can be canvassed by anonymous surveys, in which the data can be aggregated to expose various trends, which can provide management with important feedback, e.g., regarding which geographical locations might be more or less receptive to a particular idea. Trend analysis capabilities provided by the software can allow management to monitor implementation and reception of a business innovation. The software can also be used to augment Employee Relationship Management (ERM) software and help increase return on investment (ROI) on existing technology purchases.

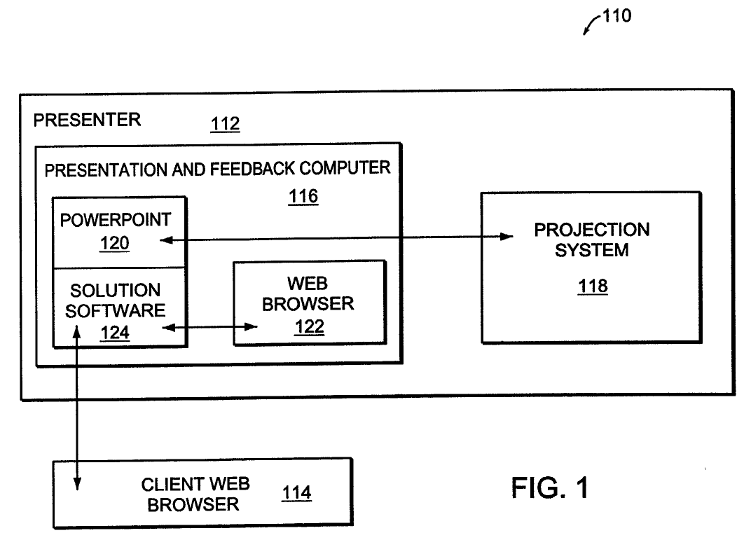

FIGS. 1-3 illustrate components of sample presentation solution systems. FIG. 1 illustrates a presentation system 110 that may be used in the example embodiment described below. System 110 includes a presenter system 112 that communicates with a client Web browser system 114. System 112 includes a presentation and feedback computer system 116 and a projection system 118. Computer system 116 runs presentation software 120 (which drives projection system 118), presenter Web browser software 122, and solution software 124 that interacts with presentation software 120, browser software 122, and client Web browser system 114.

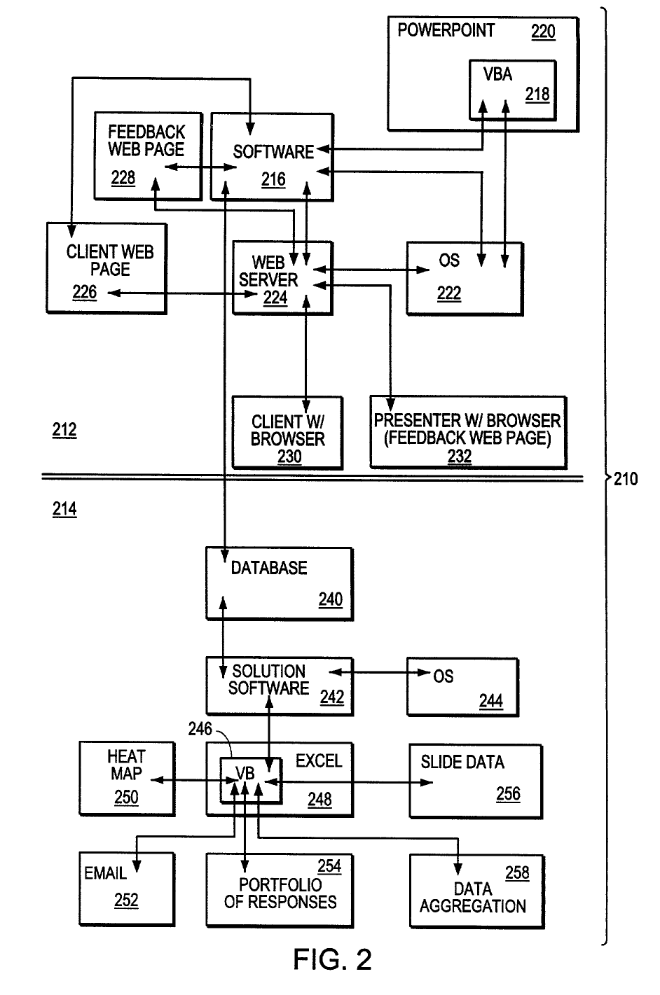

FIG. 2 illustrates a variation 210 of system 110 organized into presentation oriented subject matter 212 and analysis oriented subject matter 214. With respect to presentation, solution software 216 communicates with a scripting (“VBA”) interface 218 of presentation software 220 to affect the output of the software 220, and with operating system software 222 and Web server software 224 to create and/or affect client and feedback Web pages 226, 228 that may be sent to a client with browser 230 and a presenter with browser 232, respectively. With respect to analysis, a database 240 interacts with and is supplied with data by solution software 216. Other solution software 242 interacts with and receives data from database 240 and communicates with operating system software 244 and a scripting (“VB”) interface 246 of spreadsheet software 248 to produce heat map analysis data 250, an electronic mail update or notification 252, response portfolio data 254, slide data 256, and/or data aggregation data 258.

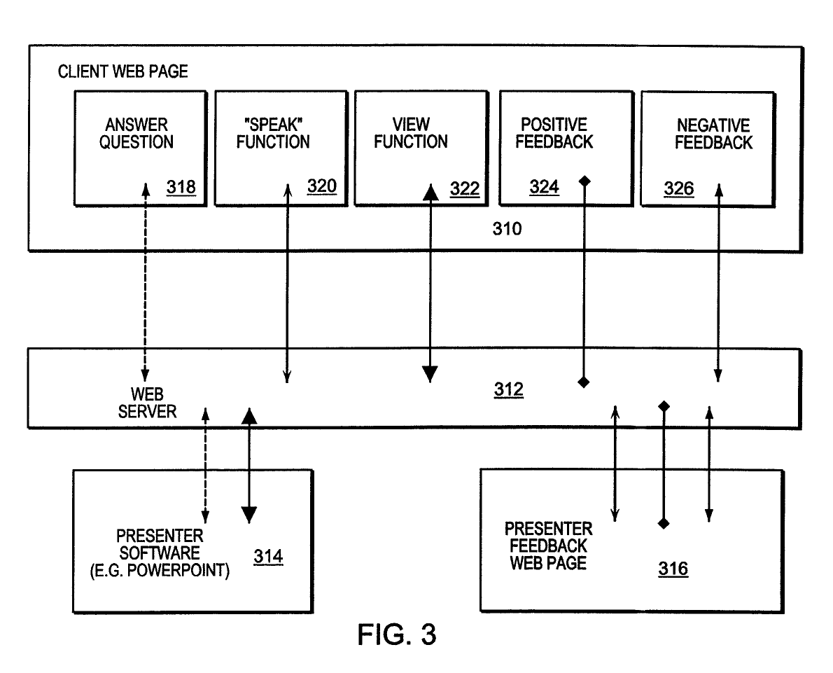

FIG. 3 illustrates client-oriented interaction in an embodiment of the presentation solution. A client Web page 310 having multiple functions 318-326 interacts with Web server software 312 which interacts with presentation software 314 and a presenter feedback Web page 316. Software 314 is affected by an answer question function 318 and a view function 322, and page 316 is affected by a speak function 320 and positive and negative feedback functions 324, 326.

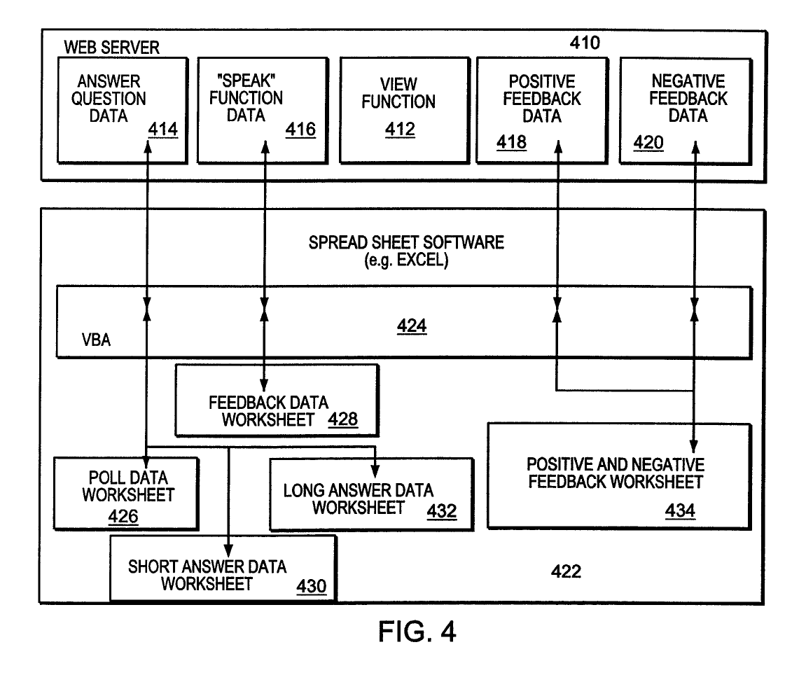

FIG. 4 illustrates analysis-oriented interaction in an embodiment of the presentation solution. Web server software 410 having a view function 412 and multiple types of data 414-420 interacts with spreadsheet software 422, which has a VBA interface 424 and multiple worksheets 426-434. Answer question data 414 affects poll data worksheet 426 and short and long answer data worksheets 430, 432. Speak function data 416 affects feedback data worksheet 428. Positive and negative feedback data 420, 422 affect positive and negative feedback worksheet 434.

In a sample embodiment using Microsoft PowerPoint as described below, solution software is installed on a computer on which presentation software such as Microsoft PowerPoint is already installed.

In order for a presenter such as a professor to enhance a presentation, the presenter downloads the solution software, which contains an add-in into PowerPoint, onto the computer that will be used to create and to give the presentation. Once the download is complete, the presenter installs the add-in into PowerPoint. To do so, the presenter opens PowerPoint, selects “Tools” from the main tool bar menu, and selects “Add-Ins” from the drop down menu. The presenter selects the add-in from the available Add-Ins menu and selects the “Add New” button to complete the installation into PowerPoint.

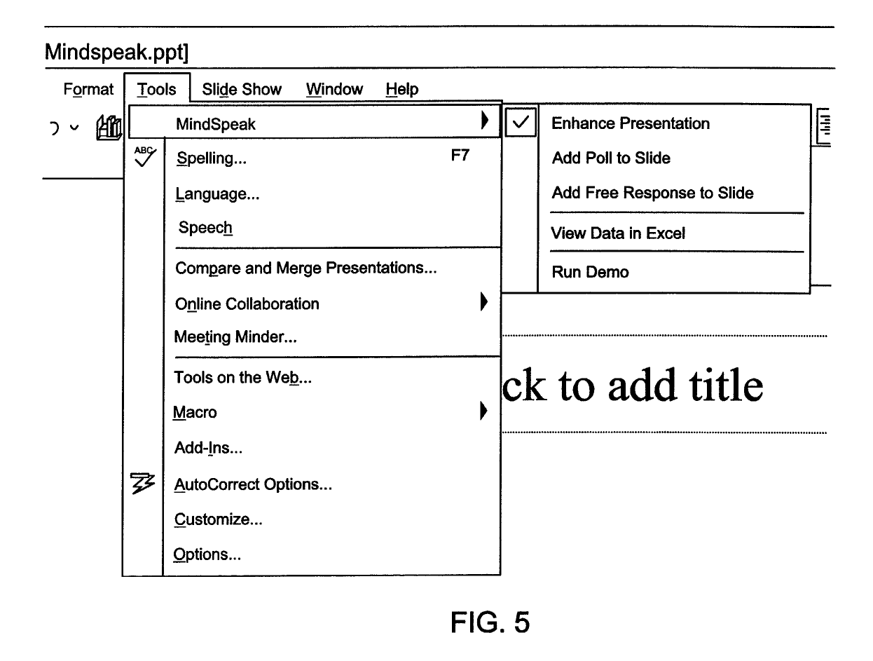

Before starting a presentation, the presenter opens PowerPoint and begins to create a conventional PowerPoint slide show. As a presenter continues to create the slide show and decides to enhance a particular slide with features from the solution software, the enhancement is accomplished through the solution software's one-click integration. As shown in FIG. 5, the presenter selects “Tools” from the main tool bar menu and select the solution software (e.g., labeled “MindSpeak”), which prompts the presenter to either choose to add a poll to a particular slide or to add a free response question to a slide. In each case, the presenter is further prompted to type in the question he would like to ask his audience. In the case of the “add poll to slide” feature, the presenter is asked to type in the possible responses that the students may select when answering the question. The presenter can decide whether there is a right answer, and if so, can designate which is answer is correct. Once the information has been entered for the “add poll to slide” feature and/or the “free response” feature, the presenter selects “add” in order to imbed the feature into the PowerPoint slide.

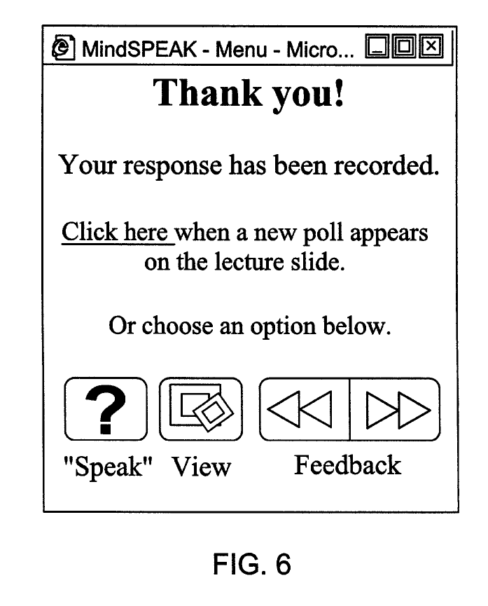

During the presentation, the presenter begins the PowerPoint slideshow and prompts the audience to use their mobile computing devices to connect to a Web page and server that is being generated by the presenter's computer, by typing in the IP address of the presenter's computer. Once an audience member connects to the presenter's IP address, the member then logs into the session by supplying a unique user identification and password. At this point, the member is fully logged into the session and is now able to participate and interact in real-time. FIG. 6 illustrates a view provided to the student on the student's client mobile computing device.

As the presenter proceeds through the PowerPoint slideshow, the audience members can, using their now connected mobile computing devices, submit questions or comments to the presenter, view the entire PowerPoint presentation, and provide the presenter with one-click instant feedback of both high or low concept penetration on a slide per slide basis. When the presentation reaches a point in which either a poll question or free response question is being displayed to the audience, the audience members can participate by dynamically responding to the posed questions.

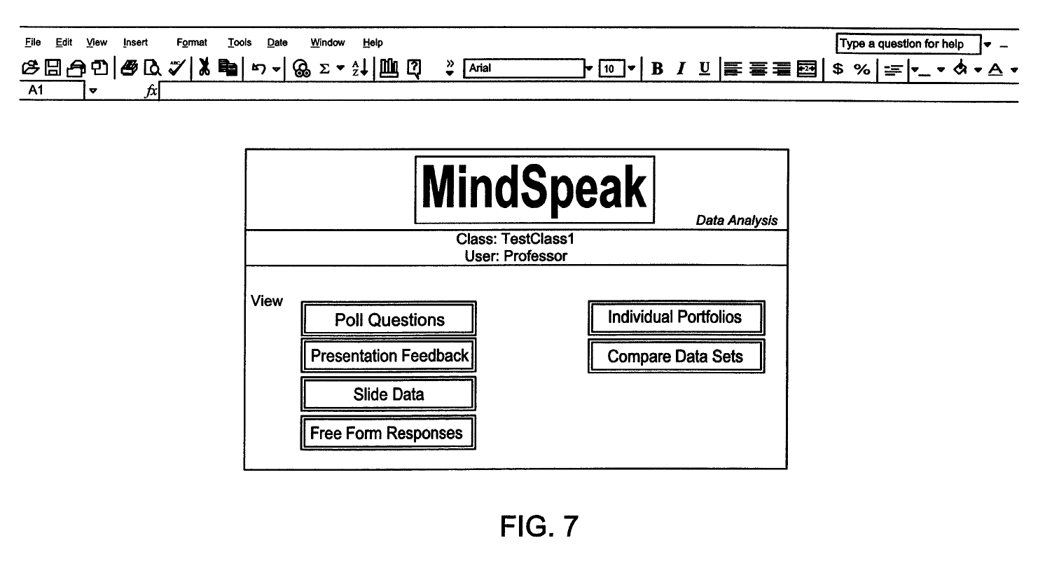

With respect to analysis of audience member feedback, the presentation solution can data mine and display in an easy to use format all of the feedback generated during a particular classroom presentation. In order to view and to begin to analyze this data, the presenter opens PowerPoint, selects “Tools” from the main tool bar menu, and selects the solution software tool application (“MindSpeak”). At this time, the presenter selects “view data in excel” (or another label if Microsoft Excel is not used). As a result, Microsoft Excel starts running, and displays the solution software's data analysis main menu, an example of which is shown in FIG. 7. From this menu, the presenter can view the responses from the poll questions and the free response questions, the questions or comments submitted, and the number of feedback hits of high or low concept penetration per slide. Also, the data analysis allows the presenter to view session statistics on an entire class level and by specific features, or by individual statistical aggregation, through the software's analysis “e-portfolios” output, which is described below.

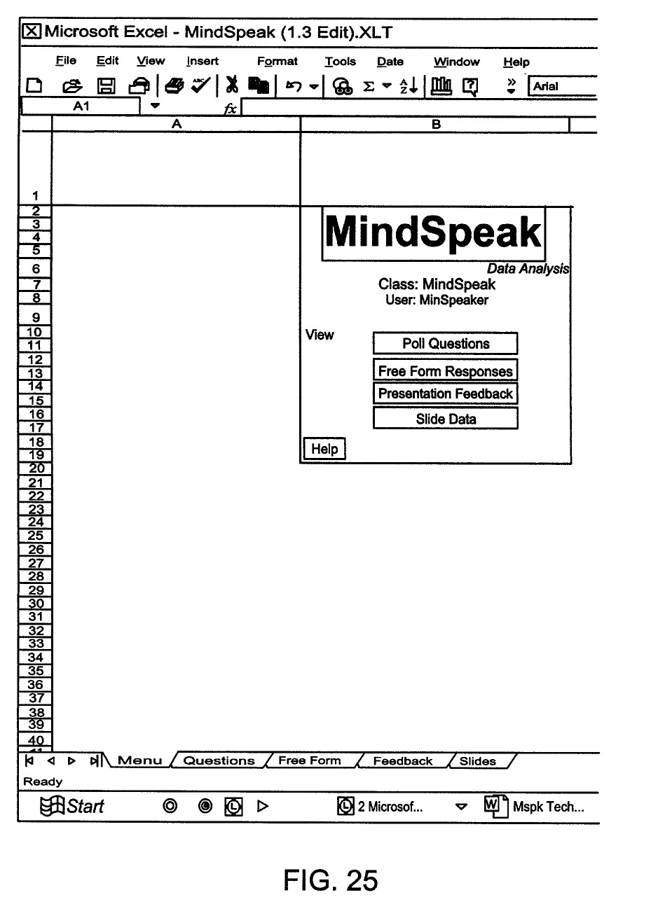

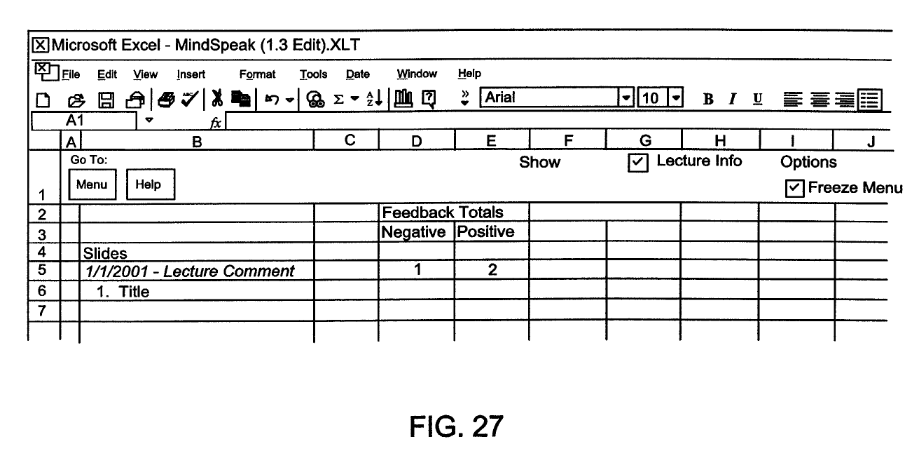

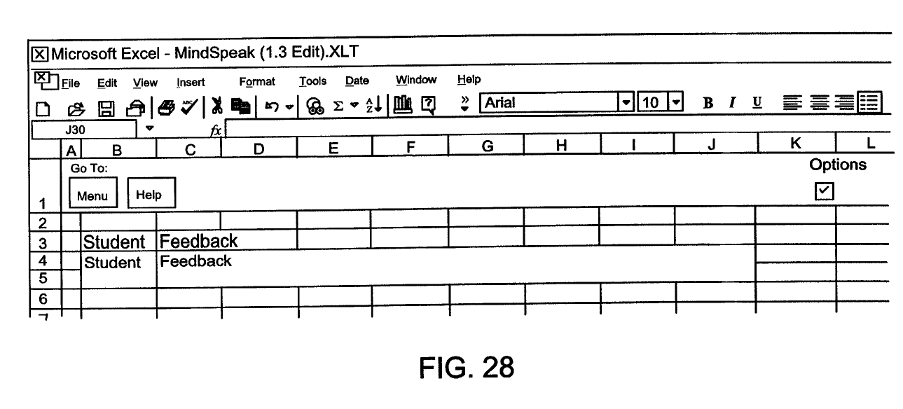

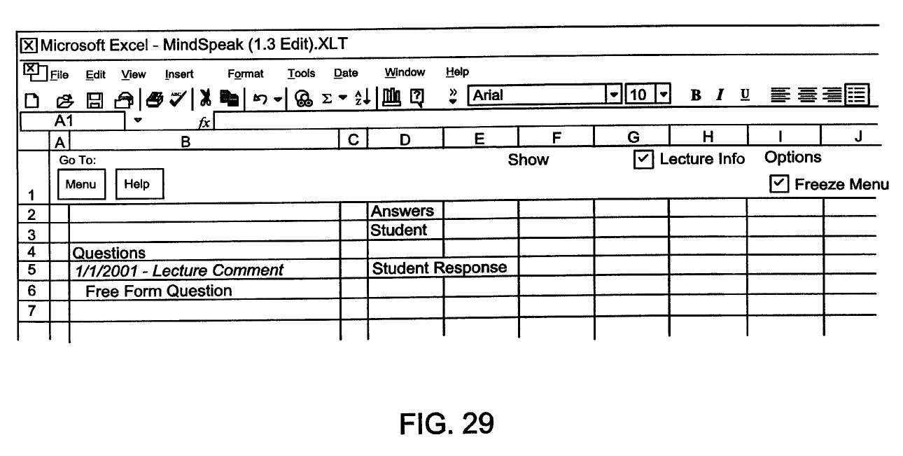

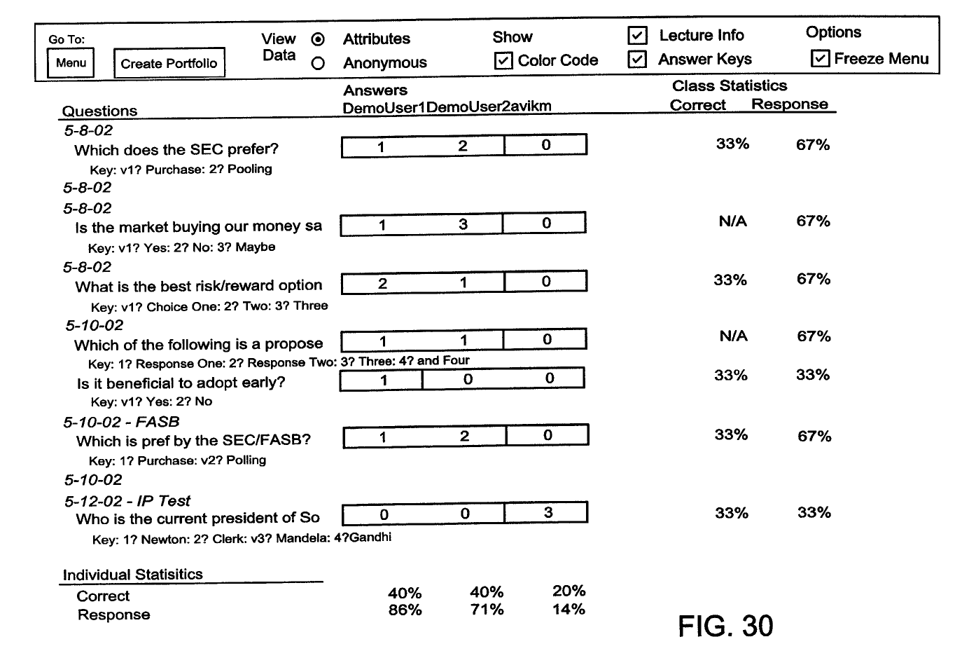

More particularly, the install process of the software (e.g., using VBA code) creates a toolbar that augments the list of commands available to the user in the presentation software (e.g., Microsoft PowerPoint). By use of these additional commands, the presentation is transformed to a tool that allows real time interaction and assessment in presentation type settings. The install process further makes available standard Web server software (“Web server)”) to the presenter on the computer that the presenter is using. The Web server allows for communication between the VBA code in the presentation and data analysis software and allows Web pages to be displayed to both the presenter and the audience member. The install process concludes by creating a customizable template using VBA code for use with off the shelf spreadsheet software (e.g., Microsoft Excel) that is used to format data for ease of analysis. (FIGS. 25-29 display templates used to format the data and FIGS. 30-33 help illustrate how the software functions when real data is generated.) For example, the VBA code allows the data to be formatted and displayed as a heat map, which in a specific example includes an n by n matrix with color coded answers to provide visual representations of the information present. The size of the matrix is determined by the number of audience members in addition to the number of questions posed by the presenter (see FIG. 30 for an example).

In a specific example of installation, a compressed (e.g., zipped) file version of the solution software with an built-in installation routine is placed on the presenter's computing device, which can be done by downloading the software from a Web site or copying the material from a piece of removable media (e.g., compact disc) (for example, the user may download the software from the MindSpeak Web site and place it on the “desktop” of a computer running a Microsoft Windows operating system such as Windows XP). The downloaded file is uncompressed using appropriate software such as WinZip which results in the creation of an executable file (in Windows based operating systems, this is typically a file with an .exe extension). Running the executable file results in the placing of all the files that constitute the solution software in an appropriate place in the file structure of the computing device (e.g., C:\Program Files\MindSpeak) and the automatic addition of the solution software (e.g., “MindSpeak”) toolbar in the presentation software (e.g., Microsoft PowerPoint).

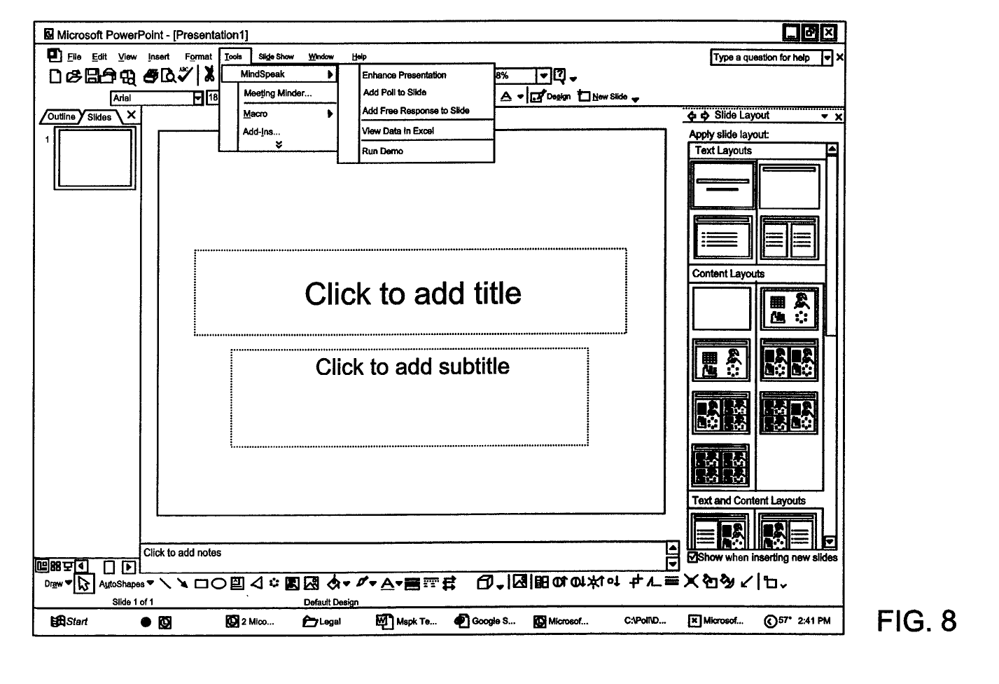

In effect, in order to install the solution software that allows standard presentation software to accept dynamic input from users, the downloaded file is placed on the computer, uncompressed, and directed to run the executable install routine. The process runs software code that interacts with the operating system and creates a new directory (that includes sub-directories and files) and makes available in the presentation software menu options that allow the adding of interaction to conventional software (e.g., done using VBA). FIG. 8 illustrates an example of a result of the addition of interaction.

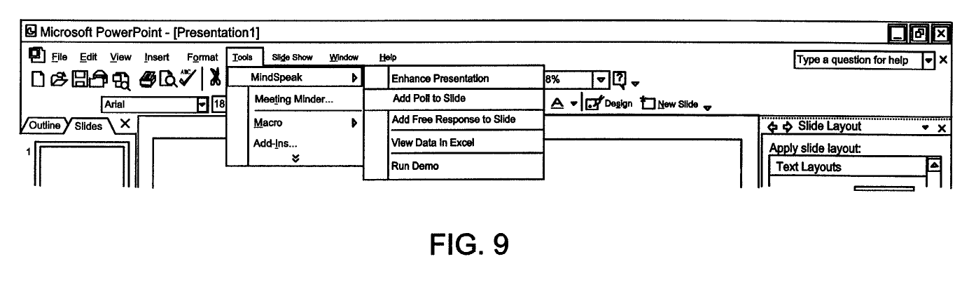

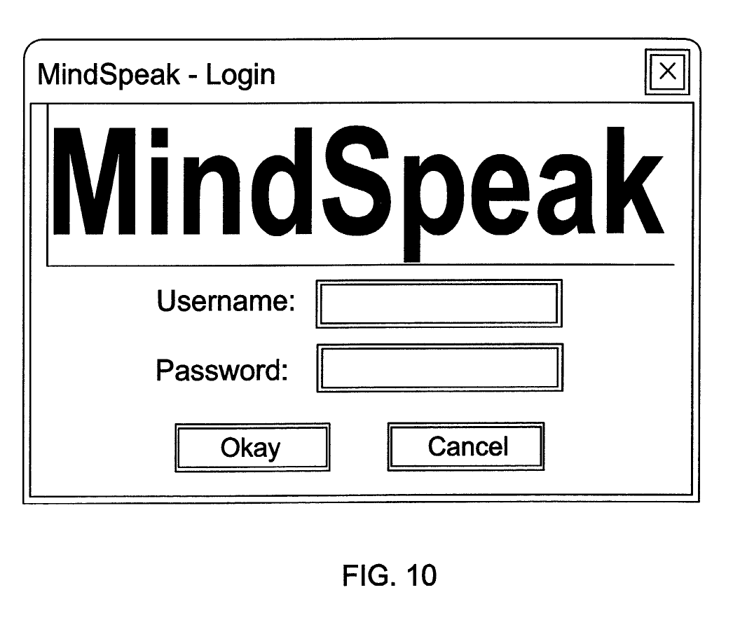

In advance of a presentation as discussed briefly above, the conventional software is transformed from a one-way communications device into a tool for interaction as follows, in a specific example. The presenter starts by opening the presentation software (e.g., PowerPoint) and creating a presentation in a conventional fashion. Using the commands made available as a result of the solution software being installed on the computer, the presenter can then add multiple choice questions with both correct and incorrect responses, short answer questions with both correct and incorrect responses, and free form responses with both correct and incorrect responses. FIG. 9 illustrates a typical example of selecting to use the commands created on the solution software (“MindSpeak” ) toolbar for enhancing the presentation. FIG. 10 illustrates a login box that is presented in response to the selection of any of the commands, to collect login data. In a specific implementation, the login box is a form created in VBA.

The login data including username and password is verified (by the Web server) against a password file made available by the institution/legal entity (e.g., school, university, corporation) where the software is installed. If the presenter's user name is not part of the password file, the presenter will have the option to create a new user name which will be for use only on that machine, because the resulting updated password file is stored on the Web server on the presenter's computer. In essence, the presenter is only required to login to the software if the presenter wishes to make use of the additional commands made available by the solution software. If the presenter despite having the solution software available would like to create a non-interactive presentation, the presenter is not required to login to the solution software.

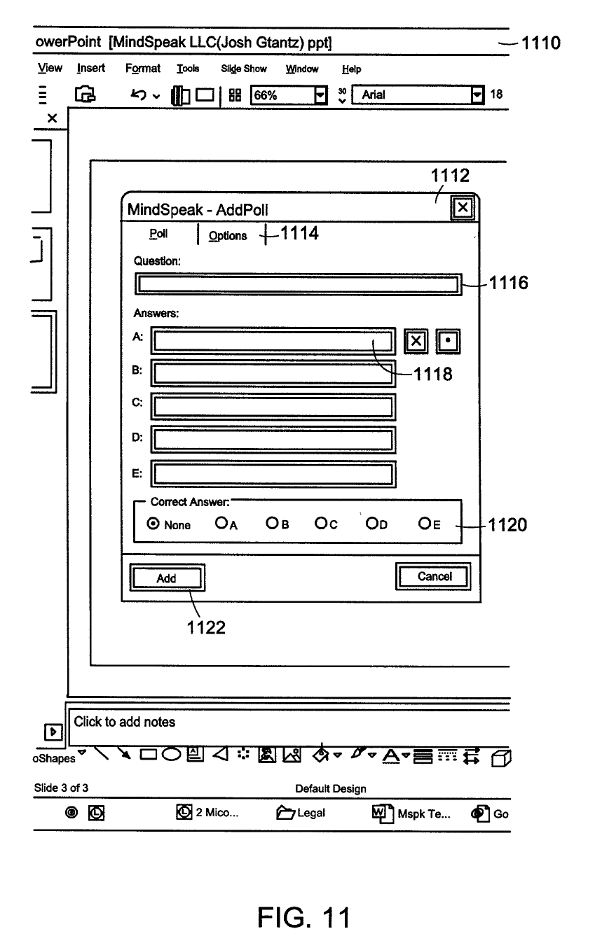

When choosing to use the solution software to enhance the presentation with interaction enabling tools such as multiple choice, short and long answer questions, the presenter types the question on a form (e.g., created and displayed using VBA) inside the presentation software and selects on that form the correct response (if any) and the amount of delay before the software updates the corresponding presentation slide (if any). FIG. 11 illustrates a typical example of the form and selection options. In FIG. 11, form 1112 is displayed over conventional presentation software 1110 and includes an options tab 1114 for reaching other options as described below, a text entry area 1116 for typing in a multiple choice question, other text entry areas 1118 for typing in choices for multiple choice answers, a selection area 1120 allowing designation of a correct answer among the multiple choice answers, and an add button 1122 for signifying completion of the form.

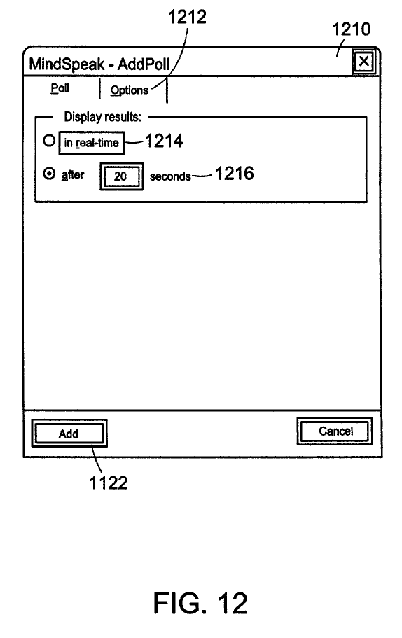

FIG. 12 illustrates a result of selecting the options tab (here, tab 1212), which produces form 1210. Form portions 1214, 1216 allow the presenter to specify how to update the slide as noted above.

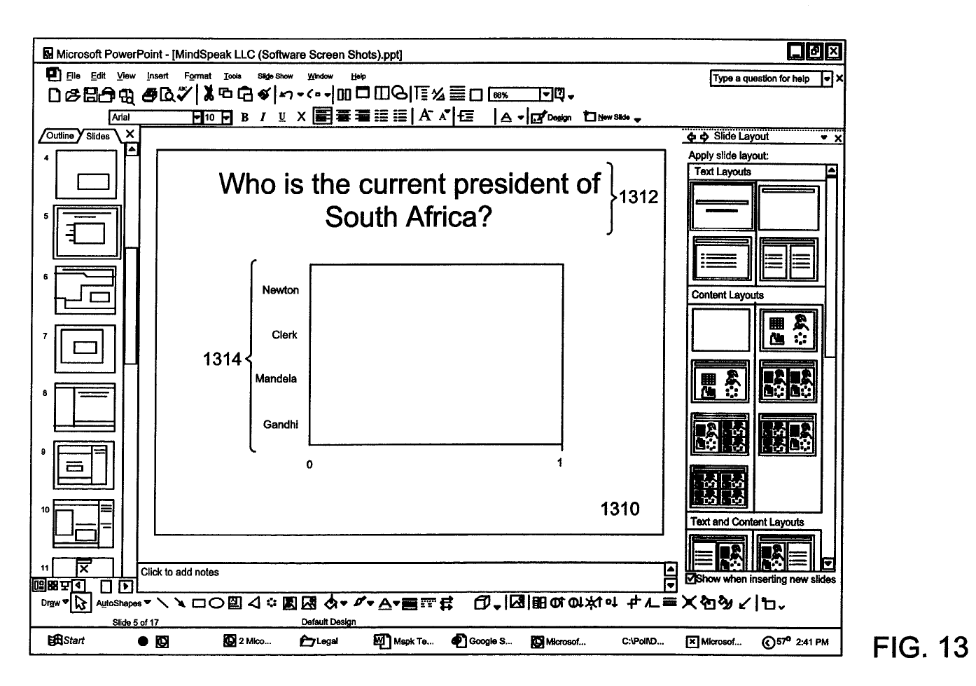

Selecting add button 1122 (FIG. 11) produces a result illustrated by example in FIG. 13. On a standard presentation software (e.g., PowerPoint) slide, the multiple choice question (from area 1116 of FIG. 11) is presented as text 1312 at the top of the slide, and the answer choices (from areas 1118 of FIG. 11) are presented as elements 1314 in a bar graph depiction.

According, a typical route that the presenter might follow for executing the “add a poll to a slide” option would involve the following steps.

1. In the presentation software (e.g. Microsoft PowerPoint) under the solution software (e.g., “MindSpeak”) toolbar, click on “Add Poll to Slide” (FIG. 9).

2. Log in to the solution software (FIG. 10).

3. Create the poll (FIGS. 11, 12).

4. Appraise the presentation slide with the inserted poll (FIG. 13).

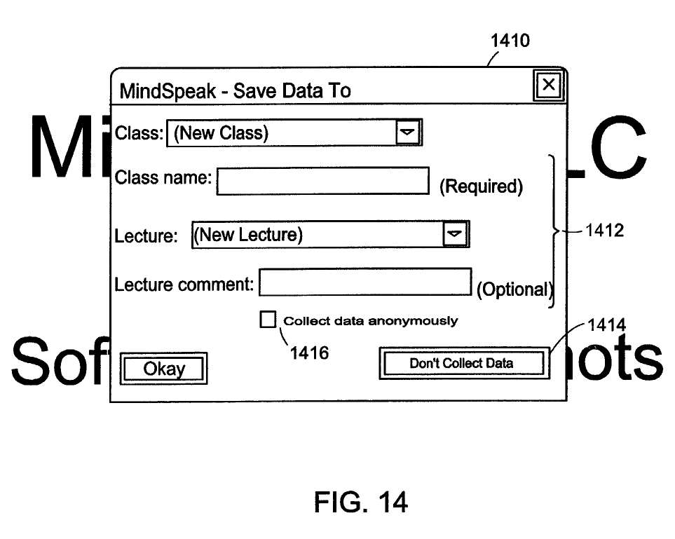

During the presentation, when the presenter is ready to begin the presentation and begins the presentation slide show (e.g., by selecting computer function key F5 in PowerPoint on computer running a Windows based operating system), the VBA software code launches the Web server. The presenter is prompted by the activated Web server to provide presentational information, such as the presentation name, topic, and whether or not the presenter wishes to collect data (the information that the clients will supply) and whether or not the presenter wishes to collect that data anonymously or with attribution (in the latter case, the client is identified to the presenter). FIG. 14 illustrates an example of a form 1410 generated using VBA code. In a portions 1412, the presenter supplies information to indicate to the Web server how the data should be stored in a database (e.g., MySql as described below) for later use in data analysis. Selecting button 1414 causes a transmission from the VBA software code to the Web server indicating that the presenter does not wish to store the data in the database. Selecting and confirming option 1416 causes the server to assign random numbers to the users who log in, and identify resulting data by the random numbers rather than the usernames entered by the users.

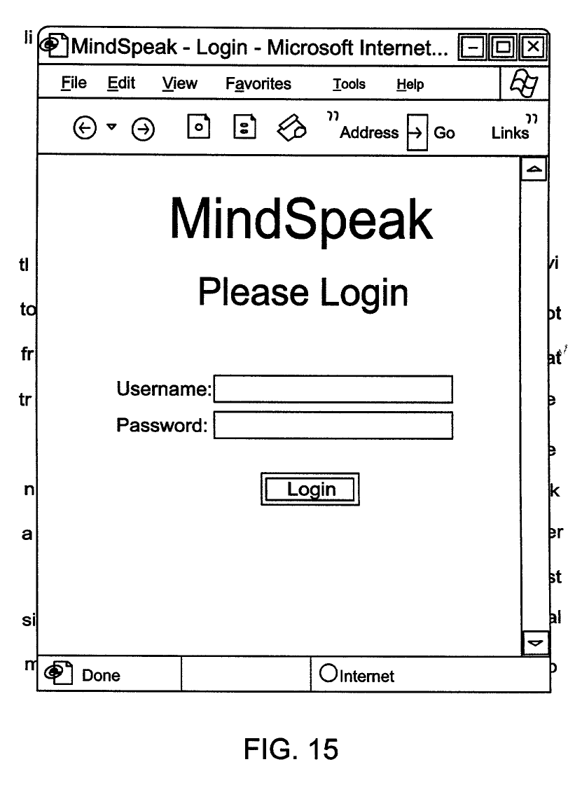

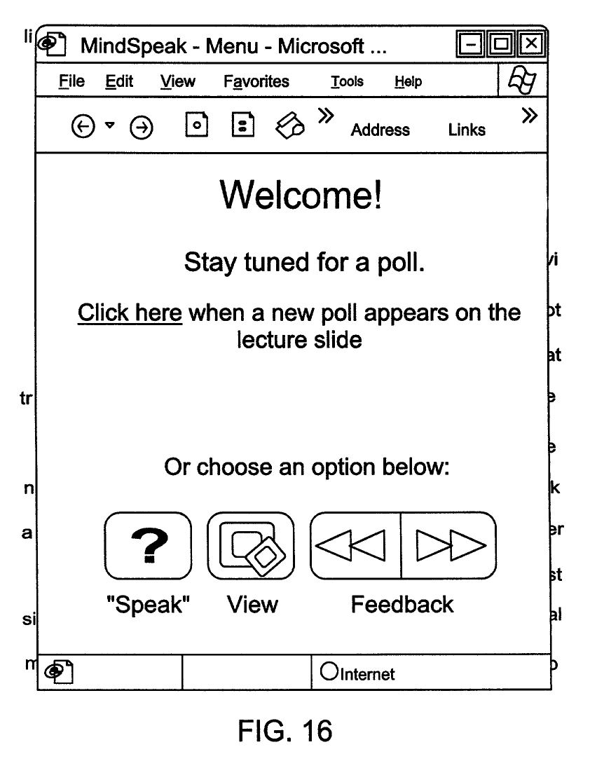

The presenter prompts the audience members to log into the Internet Protocol (IP) address of the presenter's computer, which will allow the audience to connect to a client Web page being generated by the presenter's server on the presenter's computer. The client Web page is a conventional Web page created using HyperText Markup Language (HTML) and Java, and generated using the Web server on the presenter's laptop and accessed by the client using conventional Web browser software such as Microsoft Internet Explorer or Netscape Navigator. FIGS. 15, 16 illustrate login and home page examples of client Web pages.

With respect to FIG. 15, the user logs in by typing in a username and a password and selecting the login button, which causes the username and password information to be validated by the Web server against password information stored on the institution's servers. If the username is not recognized, the user is permitted to create a new username and password specifically for use with the solution software. The Web server also monitors all logins and helps prevent users from logging in multiple times to the same IP address.

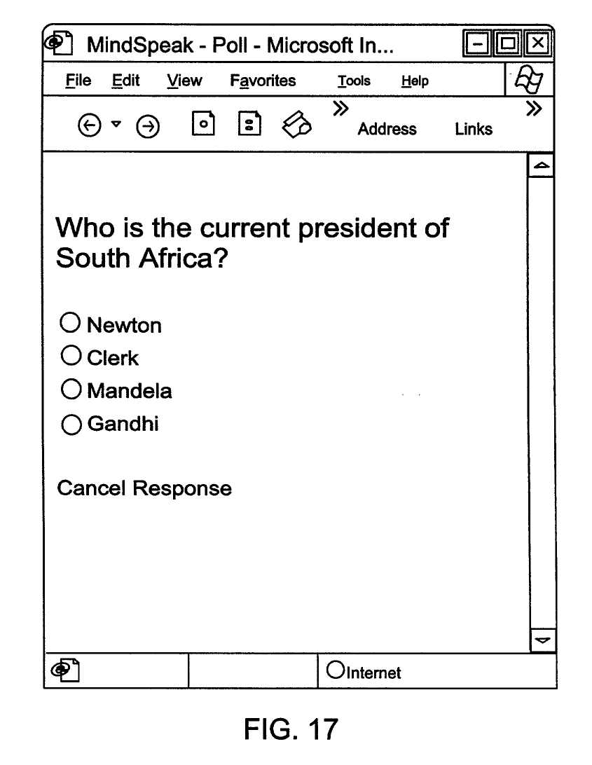

With respect to FIG. 16, selecting “click here” when a poll is available causes the Web server to replace the page of FIG. 16 with another Web page which is a respond to poll page having the poll information, which is shown by example in FIG. 17. The “speak” and “view” options are described below, as is the feedback option, in which a red left-pointing button signifies negative feedback indicating “slow down” or “don't understand” and a green right-pointing button signifies positive feedback indicating “speed up”.

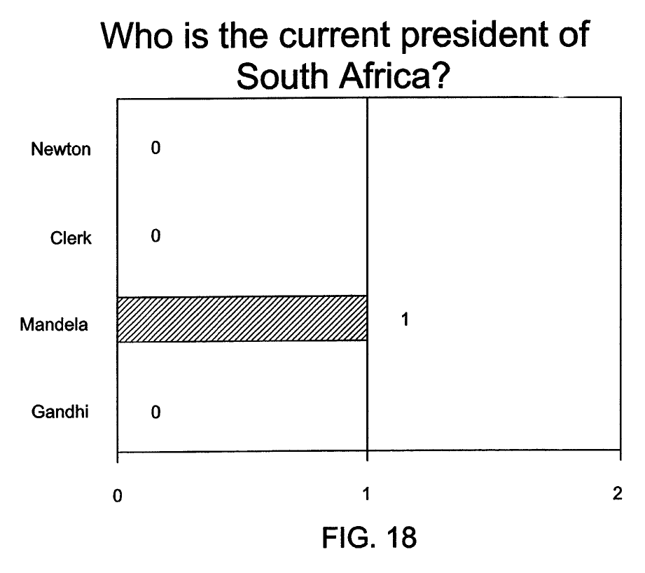

FIG. 17 illustrates an example of a respond to poll page, which has radio buttons that allow the user to submit a response to the Web server, which transmits the response information to the PowerPoint presentation for use in updating the corresponding poll to reflect the response (shown by example in FIG. 18). If the user selects “cancel response” to choose not to submit a response to the question or questions posed, the Web server replaces the respond to poll page with a page such as the example in FIG. 16 and transmits information to the database indicating that the user involved chose not to respond to the question.

FIG. 18 illustrates an example of an updated presentation slide showing the question posed (and displayed in the respond to poll page of FIG. 17) and illustrating the updated graphic reflecting the response.

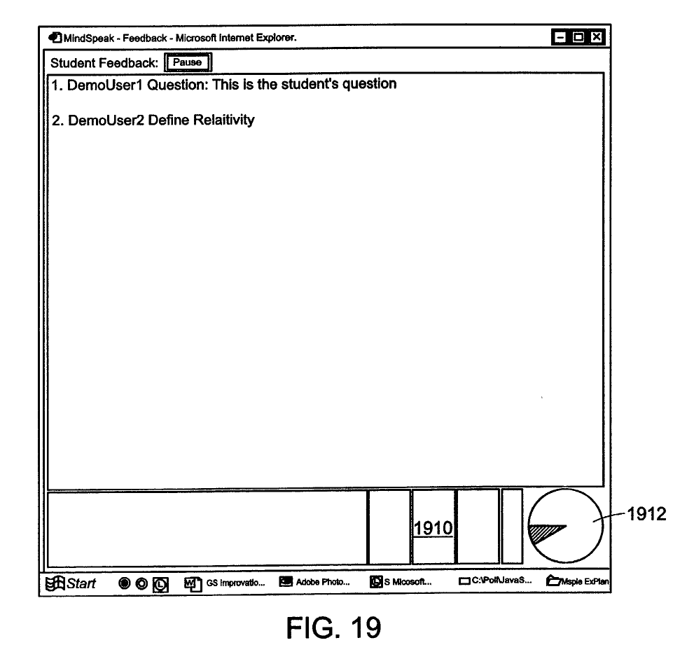

In a specific embodiment of the solution software, at any point during the presentation, the audience members have five features allowing interaction with the presenter. The first interaction takes place when a poll, short answer question, or free response question appears in the presenter's presentation, at which time the audience members are able to answer, sending all information across the wired or wireless network to presenter's server which is located on the presenter's computing device (e.g., laptop computer). When responses are submitted (by selecting the appropriate function on the client Web page) the information is transmitted to the presenter's server, and the graph in the presentation slide is either immediately updated in real-time as responses are submitted or is updated (see FIG. 18) only after a specific amount of time that the presenter has set has passed (see FIG. 12). Second, the audience members can select the “speak” option or function which allows them to pose questions or comments, as well as group those questions and comments by tagging them with general categorical names such as question, comment, define. (In all of these cases, “select” refers to the selection by the user of a specifically designated part of a Web page that brings up the corresponding Web page or allows the transmission of the corresponding information.) In this case, the information is displayed not in the presentation, but in a Web page window that is viewable by the presenter and that is shown by example in FIG. 19.

FIG. 19 illustrates a feedback screen supplied by conventional Web browser software that is used to display data sent to the browser by the Web server which collects and stores in the database all of the information submitted from the client Web pages. Lines 1 and 2 in FIG. 19 illustrate where data submitted by users using the “speak” function is displayed. The data submitted by the client Web pages is transmitted to the Web server, where the data is formatted and tagged with the usernames (e.g., “DemoUser1”, “DemoUser2”) of the users who submitted the data. FIG. 19 also illustrates a real time moving graph 1910 and pie chart 1912 that are constantly being updated with positive (green) and negative (red) feedback, with the pie chart indicating the portion of all users submitting positive or negative feedback.

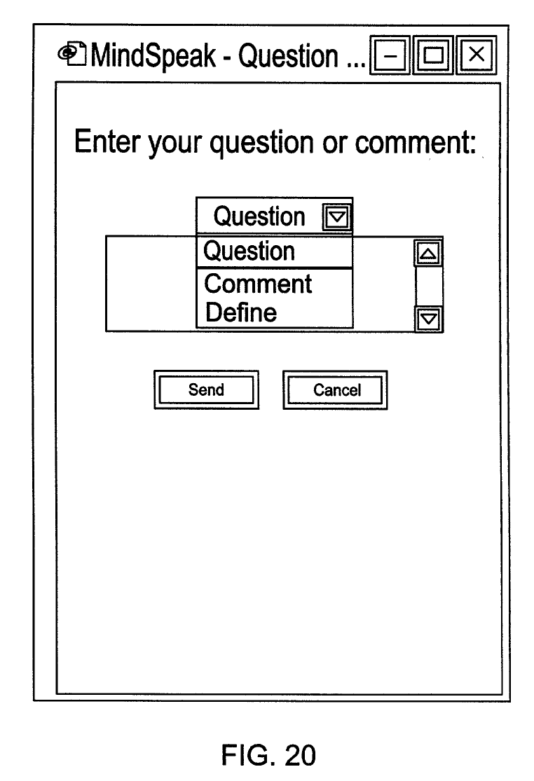

FIG. 20 illustrates an example of a “speak” Web page 2010. If the user selects the “speak” option (see FIG. 16), a transmission is sent from the client Web page to the Web server on the presenter's computer that accordingly displays the “feedback” Web page. Page 2010 includes a drop-down menu 2012 by which the user is able to select the type of feedback the user would like to submit, a text entry box 2014, and a “send” button 2016 that, when selected, results in a transmission from the client Web page to the Web server which stores the transmitted data (including the selection from menu 2012 and text from box 2014) in the database and which also updates the presenter's feedback screen based on the transmitted data (see FIG. 19).

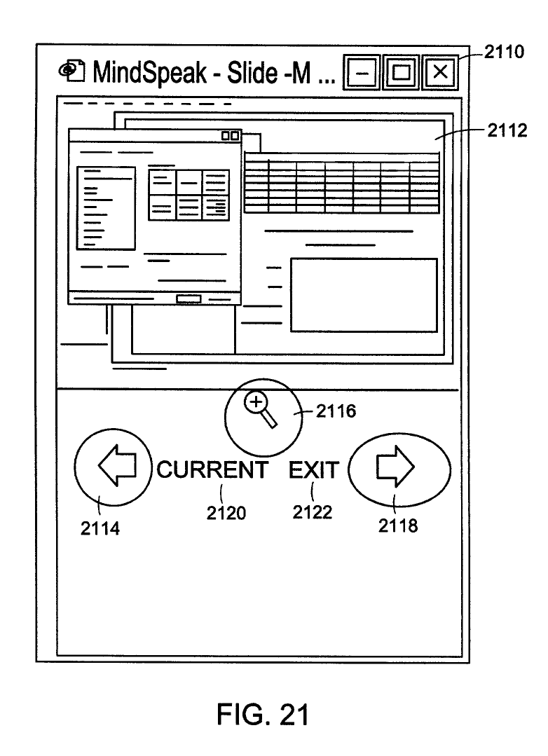

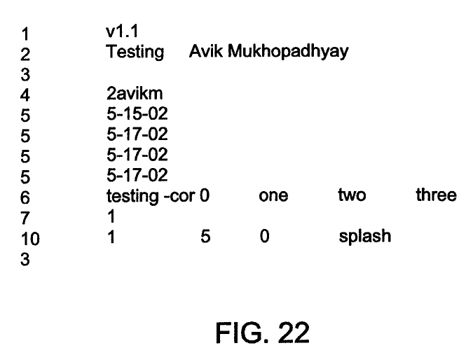

The third feature is the “view” function, which allows each audience member to view the entire presentation, to move freely back and forth between slides that have already been viewed and slides that have not yet been viewed, and to return via a single selection to the slide that is currently being displayed by the presenter. When the client clicks on the “View” feature (see FIG. 16) on the client Web page, a transmission is sent to the Web server on the presenter's laptop that recognizes the input and transmits an image of the slide that is currently being displayed by the presenter's presentation software to the client along with buttons (essentially links to images of the other slides in the presentation) that allow the client to navigate the presentation at a pace independent of the pace at which the presenter is presenting the material. FIG. 21 illustrates an example 2110 of a Web browser screen that includes an image 2112 of a presentation slide, a left-arrow button 2114, a zoom button 2116, a right-arrow button 2118, a “current” link 2120, and an “exit” link 2122. Buttons 2114, link 2120, and button 2118 allow the user to call up an image of the previous, current, or next slide, respectively, in the presentation. Selecting button 2114, link 2120, or button 2118 transmits a message to the Web server on the presenter's computer that responds with a new Web page including an image of the previous, current, or next slide (in the case of link 2120, the Web server first determines which slide is currently being displayed by the presenter). Selecting button 2116 sends a transmission to the Web server that responds with a Web page that includes a larger image of the presentation slide.

The “feedback” function allows an audience member to select either the “green” right-pointing button to electronically tell the presenter that the member understands the material, or the “red” left-pointing button to tell the presenter that the member does not understand the material. More specifically, red refers to negative feedback, and green refers to positive feedback. The positive and negative feedback is not sent to the presentation being displayed, but rather is sent to the same Web page window (see FIG. 19) in which the questions and comments are being displayed.

In a specific implementation, the flow of the data through the software is as follows:

1. On the client Web page, the client clicks on red or green button.

2. The data is transmitted to the server which records the feedback in the database against the slide currently being displayed.

3. The server transmits a Web page to the client indicating that the feedback has been received.

4. The server updates the moving graph and the pie chart on the presenter's feedback screen (see FIG. 19).

At the end of the presentation, the presenter has the ability to view all the data that was generated and collected during the presentation. The presenter has this option because all of the data that was being generated during the presentation was received by the presenter's Web server and was stored in the database. When viewed without being formatted in the data analysis/spreadsheet software, an example of the data may appear as follows (shown in FIG. 22 as well):

TABLE 1

| 1 | v1.1 | | | | |
|---|---|---|---|---|---|
| 2 | Testing | Avik Mukhopadhyay | | | |
| 3 | | | | | |
| 4 | 2avikm | | | | |
| 5 | 5-15-02 | | | | |
| 5 | 5-17-02 | | | | |
| 5 | 5-17-02 | | | | |
| 5 | 5-17-02 | | | | |
| 6 | testing -cor | 0 | one | two | three |
| 7 | 1 | | | | |
| 10 | 1 | 5 | 0 | splash | |
| 3 | | | | | |

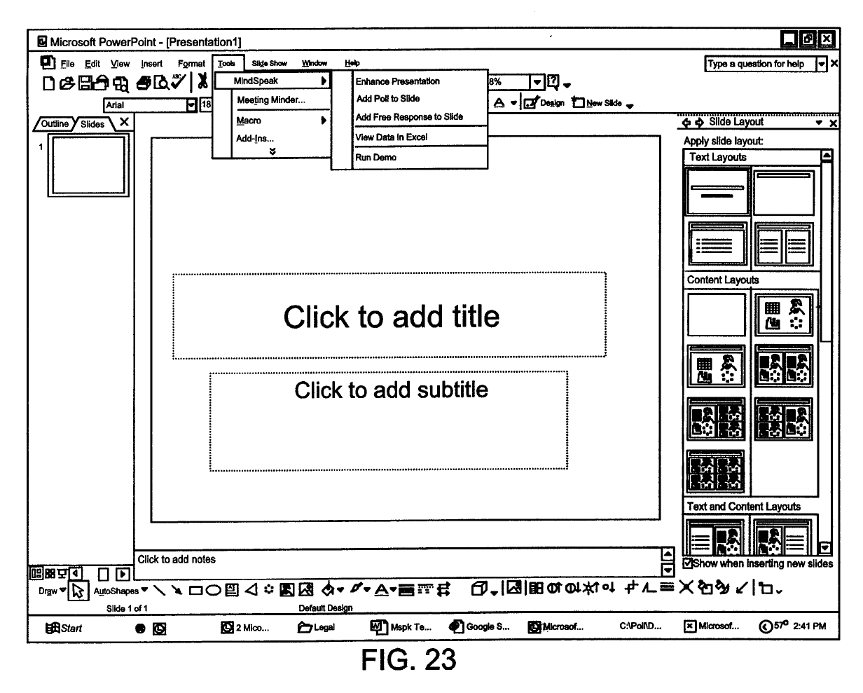

When the presenter returns to PowerPoint after the presentation and navigates through the presentation software's command options which have been placed there as a result of VBA software code, and selects the solution software (e.g., MindSpeak) options, the presenter can select “view data in excel.” In PowerPoint, the menu may typically appear as shown in FIG. 23.

when the “view data in excel” function is selected, the data analysis/spreadsheet software (e.g., Microsoft excel) retrieves the data from the database (e.g., MySql database) and formats the data based on the template (see FIGS. 25-29) to be able to display the data in the data analysis/spreadsheet software (e.g., Microsoft Excel). The data is first transmitted from the MySql database to the data analysis/spreadsheet software in a comma separated format and is imported into a hidden worksheet.

Effectively, the display of the data can be viewed as the following steps:

1 The presenter launches the presentation software.

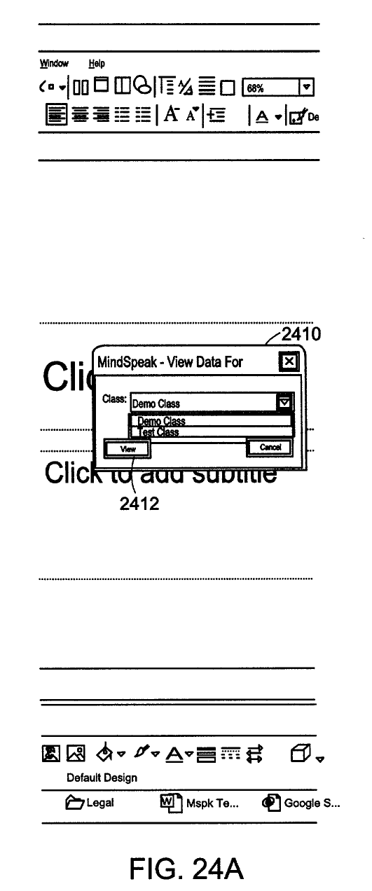

2. The presenter selects the “view data in excel” option from the presentation toolbar menu options which results in the launching of a VBA form (shown by example in Fig.24) which is populated with information from the Web server about the data sets that are stored locally on the presenter's computer and are available for selection.

3. The transmission of the selected information from the VBA form to the Web server on the presenter's laptop results in the Web server accepting this information and releasing the required information from the database in a format that can be imported into the data analysis/spreadsheet software (e.g., as shown in Table 1 above).

4. The released information is imported into a hidden worksheet in the data analysis/spreadsheet software.

5. The visible worksheets in the data analysis/spreadsheet software format the data on the hidden sheet in a manner to make the data easy to visibly digest. FIGS. 25-29 illustrate outlines of the templates used to format the data into visually appealing forms, and FIGS. 30-33 illustrate outlines of a typical set of presentations having data formatted using the Excel templates.

FIG. 24 illustrates a “view data for” form 2410 for which a list is populated with information from the database, and selecting a “view” button 2412 in the form results in a transmission to the Web server which seeks data for the selected class for display.

This data is formatted based on a template that is created using the data analysis/spreadsheet software that is supplied when the solution software is first installed. If Excel is used as the data analysis/spreadsheet software, then the template may resemble the worksheets shown in FIGS. 25-29. (The template is a collection of worksheets that are formatted in a particular way to display the data.)

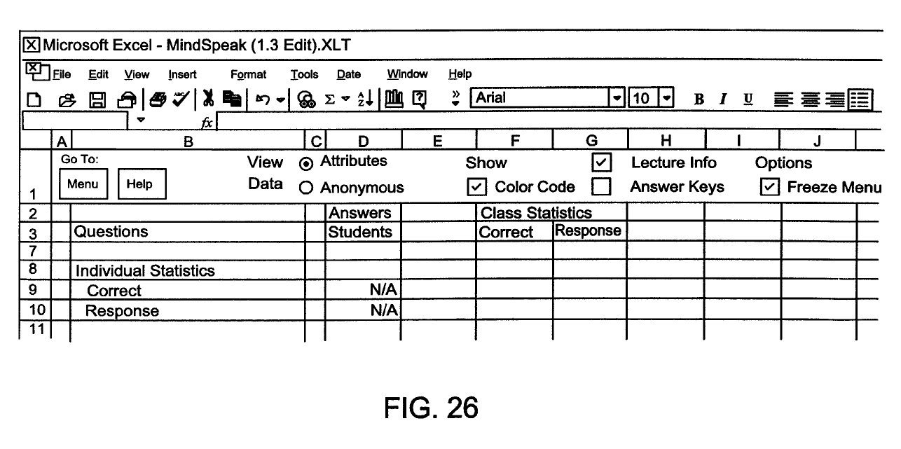

FIG. 25 illustrates a menu tab screen for a template example, which includes customized buttons and worksheets created using VBA software code. FIGS. 26-29 illustrate questions, free form response, feedback, and slides tab screens showing typical formats. All calculations and statistics are produced using conventional calculations available in the data analysis/spreadsheet software, with information supplied by the hidden worksheet as necessary.

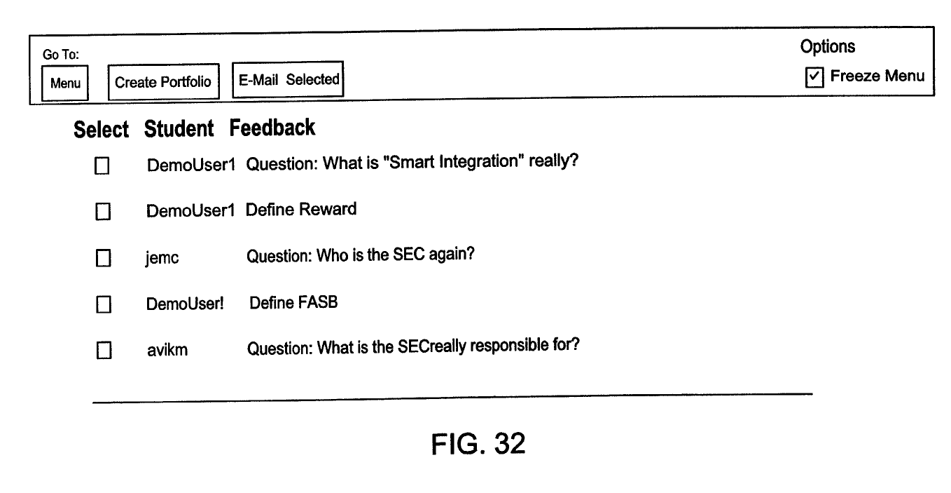

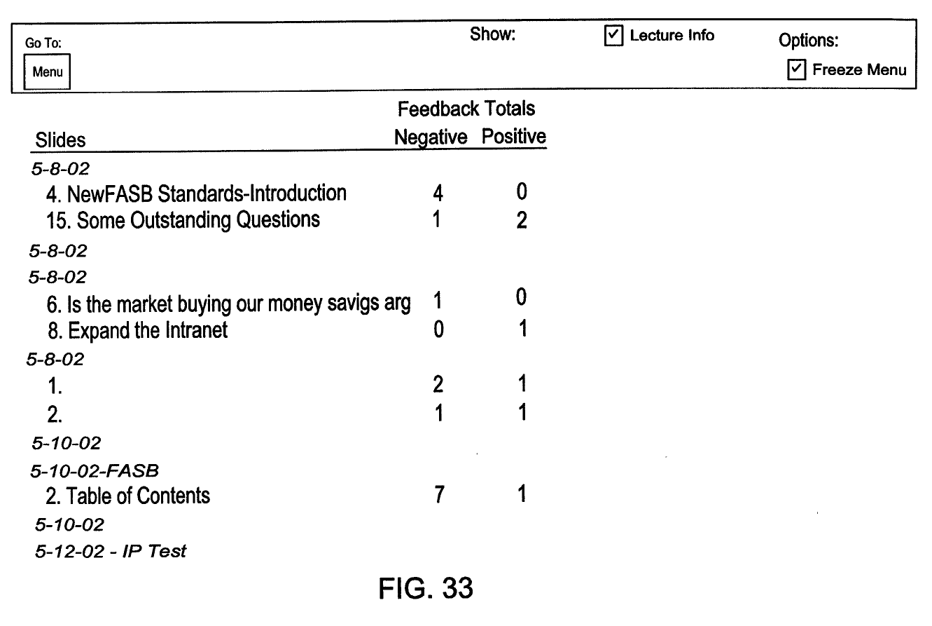

The server software interacts with the operating system and launches for the presenter the data analysis/spreadsheet program with a workbook based on the template. For example, in Excel, the presenter is sent to a worksheet with the main menu, in which the presenter can select to view the poll data (shown by example in FIG. 30), the short answer data, the free response data, the “speak” data (shown by example in FIG. 32), and the slide data (shown by example in FIG. 33).

When the presenter selects to view the poll data by clicking on the “Questions” tab, the presenter is sent to another worksheet in which the presenter can modify the information to the presenter's preferences and needs, which is done using VBA software code. For instance, the presenter has the ability to view the lecture information (class name and date) in which a particular poll was given. The presenter can also view and turn on and off the poll questions that were asked, the choices given, and whether or not there was a correct answer (see FIG. 26). In a specific implementation, upon clicking on any of these options the VBA software code accordingly modifies the worksheet; there is no communication to the Web server nor any additional data being transmitted from the Web server on the presenter's computer to the data analysis/spreadsheet software.

Visually, the presenter is able to determine whether or not the audience member got the poll correct, incorrect, or did not respond, as well as determine whether there was a correct response designated originally by the presenter. The software code operates by assigning a color code to the responses: red designates an incorrect response, green designates a correct response, yellow designates a response with a correct answer that was not answered, tan indicates that the audience member responded to a question with no correct answer, and black refers to a poll in which the audience member did not participate.

As a result of this coded color designations as illustrated by example in FIG. 30, the software provides the presenter with a heat map of concept penetration, in which the presenter can visually and quickly determine the audience member's understanding of the concepts being presented. Furthermore, the presenter can either choose to view the data anonymously or attributed (anonymously meaning that the presenter will not be able to trace back the responses to the individual user who submitted the response; in the attributed mode, the presenter is able to do so). Since each poll response either has a response or no response, and either a correct or incorrect answer, the software as a result automatically calculates for each individual audience member and for the overall class certain statistics, such as the percentage of responses correct and the percentage of polls responded to.

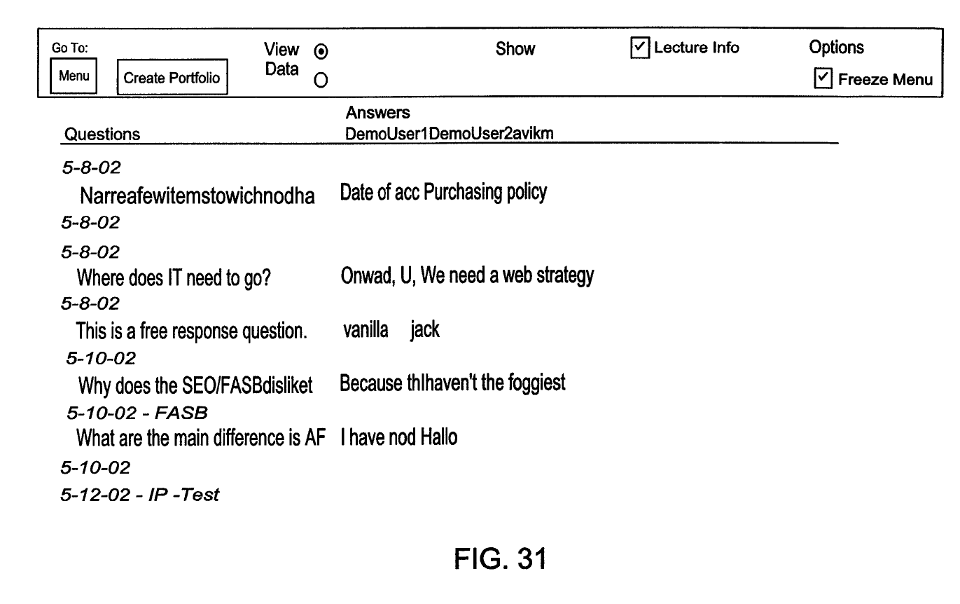

In a similar fashion, shown by example in FIG. 31, the presenter can view the data on the short answer questions, free form questions, and the various questions and comments that were sent to the presenter during the presentation. In the corresponding three worksheets, the presenter views each response or comment by the presentation's name and data and tagged to either an audience member or a randomly generated number as described above.

With respect to examples in FIGS. 32, 33, the presenter can also view the positive and negative “feedback” that was offered by the audience members selecting either the green or red buttons as described above. The data is again displayed by presentation name and date. More specifically, within a particular presentation, the presenter is able to view the feedback on each slide that was given allowing the presenter to assess those topic areas that the presenter had difficulty communicating to the presenter's audience members (see FIG. 33).

In each case with respect to FIGS. 30, 31, 32, 33, data is obtained from the hidden worksheet and formatted using templates shown in FIGS. 26-29, respectively.

VBA software code may be used to provide methods as described herein, but one or more other programming languages may be used as well as, or instead of, all or a portion of the VBA software code.

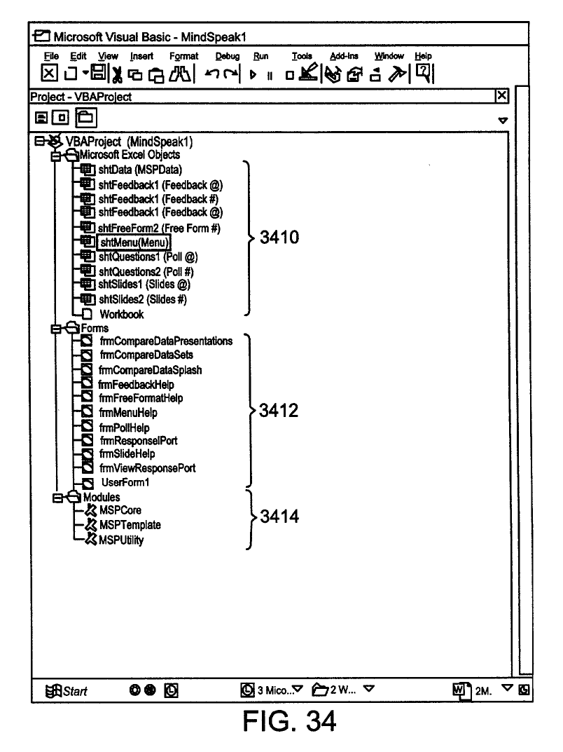

FIG. 34 illustrates an example showing how, in VBA software code, components of the Excel template may be organized. Portion 3410 shows workbook sheets that are used, portion 3412 shows forms that are used to accept user input or display information to the user, and portion 3414 shows core modules of software code that include subroutines that are called from the PowerPoint Add-In and the Excel template sheets to access the solution software data.

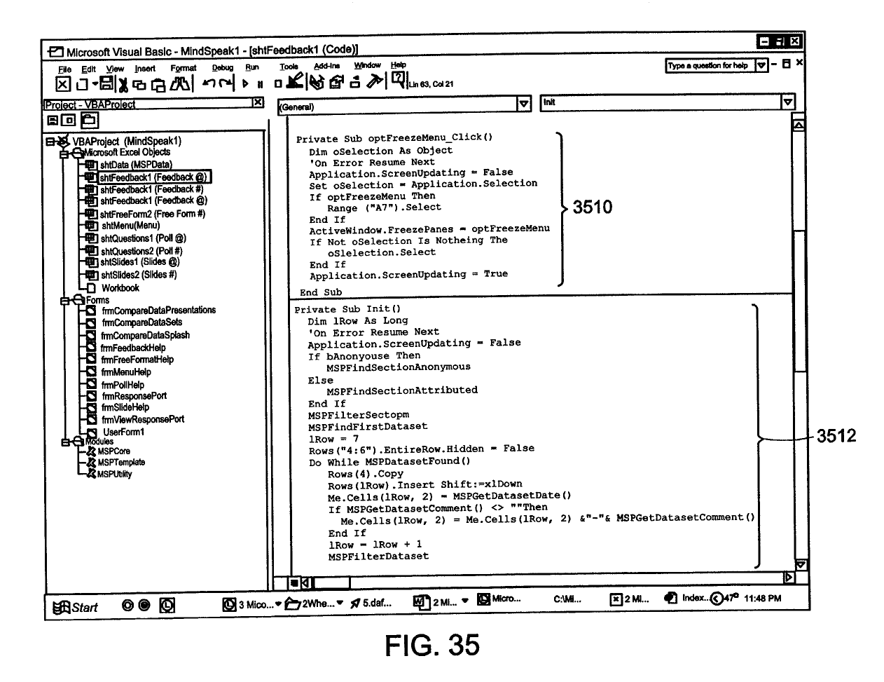

FIG. 35 illustrates an example of software code (not necessarily complete) in a Microsoft Excel Object (specifically object “shtFeedback1 (Feedback @)”). Portion 3510 pertains to a freeze menu option; if a user selects this option, the menu is always visible; if not, the menu is not always visible when the screen scrolls (see FIGS. 26-29). Portion 3512 generates the Excel sheet that contains feedback submitted by users. Subroutines having the prefix “MSP” reside in core modules and allow access to solution software data. The code of portion 3512 loops through all of the feedback, copying and formatting the raw data onto the Excel sheet.

The code listed below illustrates an example of software code from another Microsoft Excel Chart object. The code generates the Excel sheet that displays the polls and responses submitted by users. Subroutines having the prefix “MSP” reside in the core modules and allow access to the solution software data. The code segment loops through all of the polls, copying and formatting the raw data onto the Excel sheet. The use of the solution software core libraries allows simple access to the solution software data without reliance on knowledge concerning where the data is stored or how it is formatted.

It may be possible to create a solution software data template with little or no reliance on Excel macro coding. The underlying data storage and format could also be changed by modifying only the core libraries, leaving all other template code intact. In a specific implementation, the data is extracted from the database and placed specially formatted onto a hidden sheet in Excel, but only the core libraries rely on this characteristic.

[image]

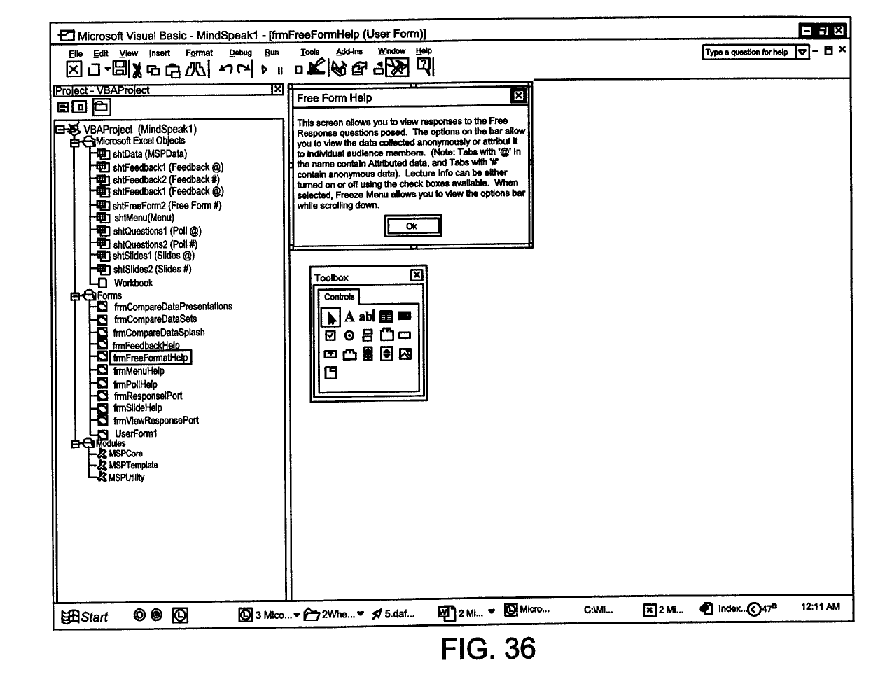

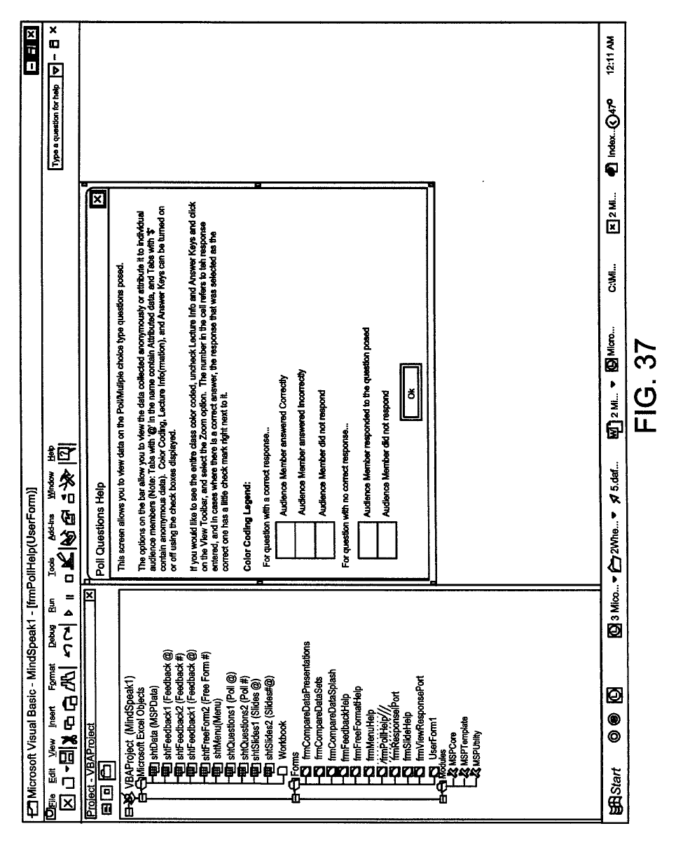

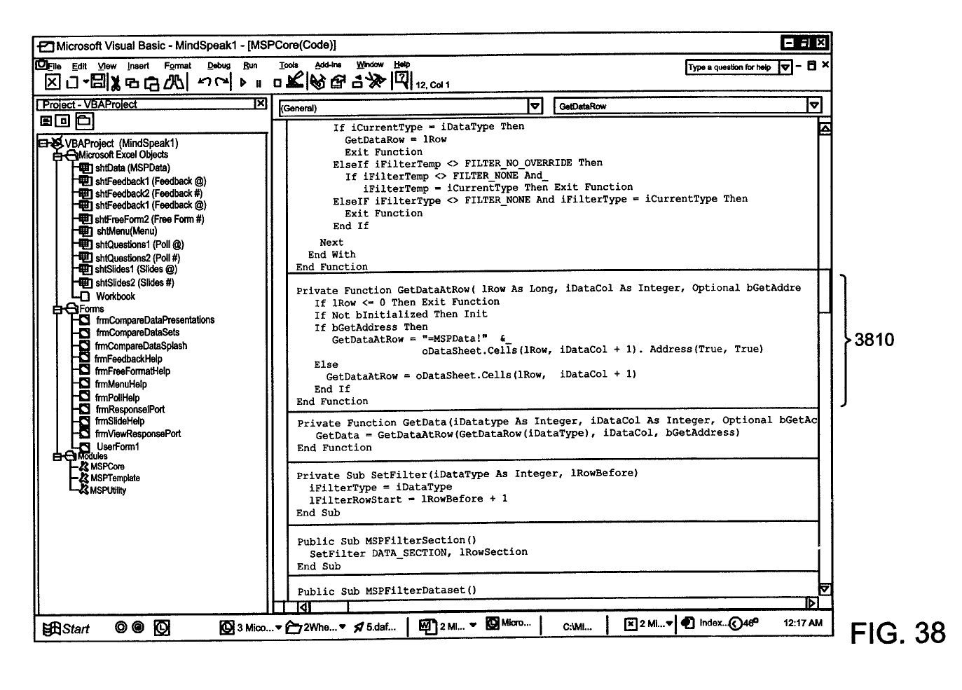

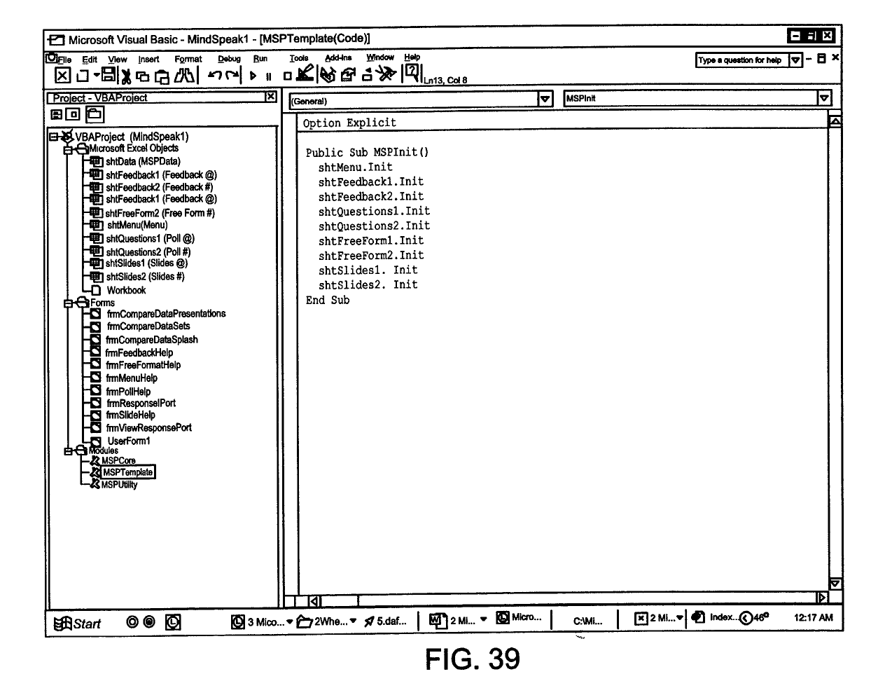

FIGS. 36, 37 illustrates examples of help forms created in VBA software code, specifically, form “frmFreeFormHelp” and form “frmPollHelp”, respectively, as listed on the left in FIGS. 36, 37. FIG. 38 illustrates an example of module code for module “MSPCore”, including portion 3810 that represents a helper function that is called within the core library to read the raw solution software data off of a hidden sheet named “MSPData”. FIG. 39 illustrates an example of other code for module “MSPTemplate”, which is used to create template worksheets (see FIGS. 25-29), and which is called and executed by the PowerPoint Add-In when Excel is first opened.

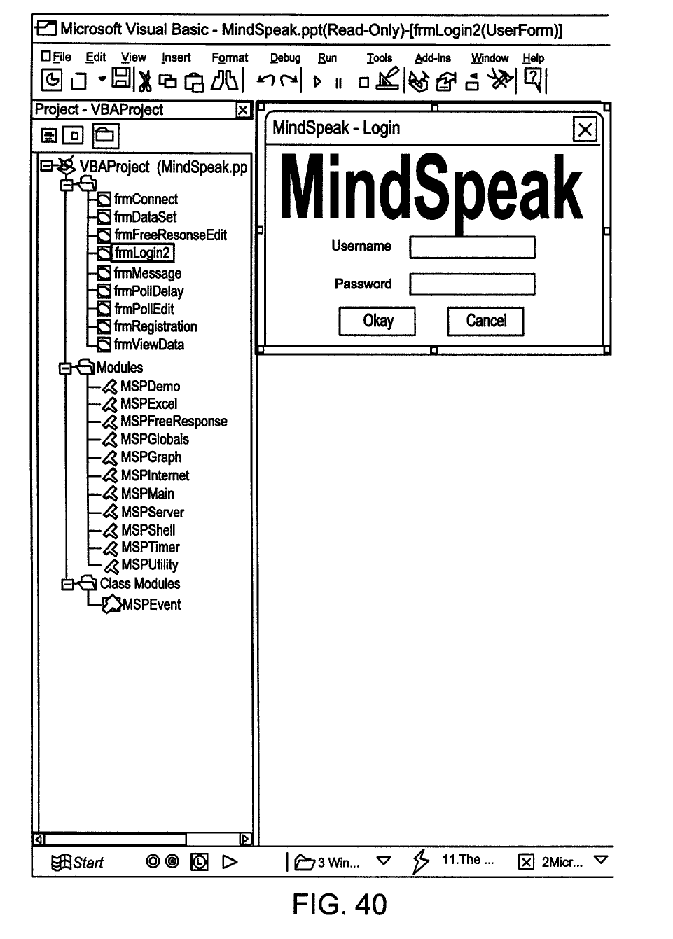

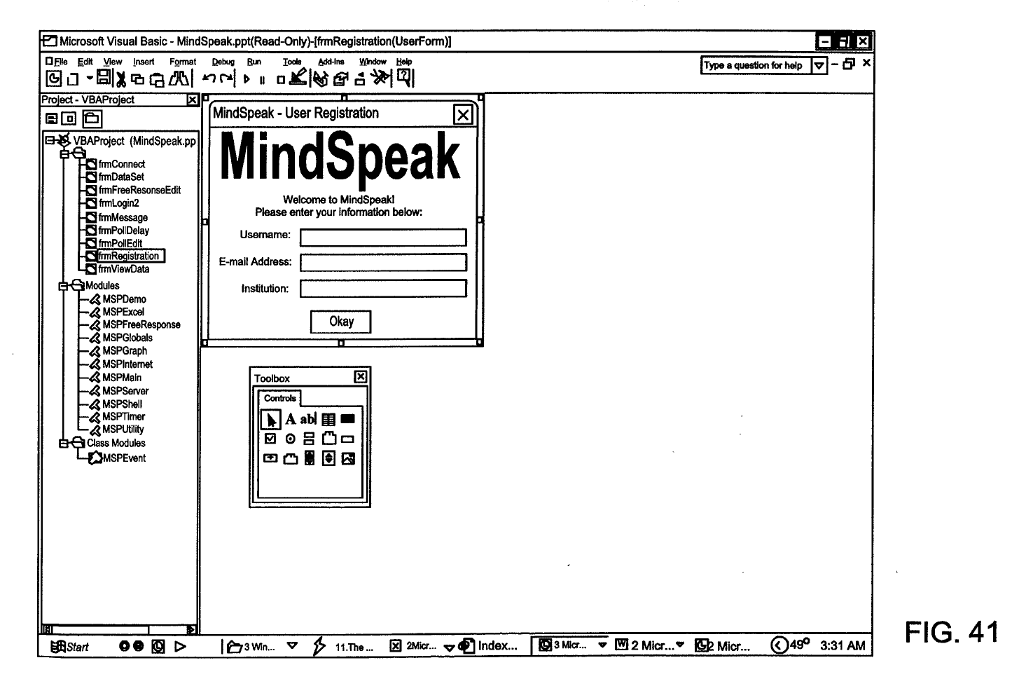

FIGS. 40, 41 illustrate examples of VBA software code in PowerPoint, specifically form “frmLogin2” and form “frmRegistration”, respectively, which are standard forms having standard text fields that accept user input. Control toolbox 4110 contains shortcuts to all of the tools that were used to create the forms used in the software in a specific implementation.

The code listed below illustrates examples of software code in the solution software. The code below is from MindSpeakTables.txt, and is the SQL (Structured Query Language) code that creates the database, which consists of a series of tables with named values of various data types as columns, and entries (a response to a poll, for example) as rows. This code defines the initial database structure of tables and columns. The actual data is added one row at a time by the server.

[image]

The code below is a portion of the code that adds a poll response to the database. An “INSERT INTO” SQL statement is constructed containing the data to be inserted in a new row into the table named “tblPollResponses”. The statement (stmt) is then run and the table updated.

[image]

The code below is a portion of the server's Java servlet code, which code is run whenever a Web request is made either from an audience Web browser, the PowerPoint Add-In, or a real-time feedback applet. The servlet responds according to the request's “action” parameter.

[image]

The following code is a sample that demonstrates the dynamic creation of an HTML Web page, in this case, the solution software main menu screen. Strings are constructed from a combination of static data and real-time variables and are output to the client to be displayed.

[image]

The following code is a simple Java class that is used to store information about a response to a poll. It is filled with data from an audience Web browser sent as parameters of a Web request using an HTML form. It is then written to the database by calling the function “addPollResponse” given in a previous code sample.

[image]

The following code is a portion of the PowerPoint Add-In code that allows the Add-In to interact with the server by making a Web request, just as a conventional Web browser would. Parameters are passed as part of the URL address. The response is received and parsed by the Add-In.

[image]

The following code allows the PowerPoint Add-In to capture and act upon PowerPoint events such the start of a slide show, or the navigation to a new slide during a slide show.

[image]

The following Add-In code creates the solution software menu within PowerPoint, and allows the Add-In to respond when the menu items are clicked.

[image]

The technique (including one or more of the procedures described above) may be implemented in hardware or software, or a combination of both. In at least some cases, it is advantageous if the technique is implemented in computer programs executing on one or more programmable computers, such as a general purpose computer, a networked computer, and/or a computer running or able to run a Microsoft operating system such as Windows 95, 98, 2000, Millennium Edition, NT, XP; Unix; Linux (or another variant of Unix); or MacOS; that each include a processor such as an Intel Pentium compatible processor, a storage medium readable by the processor (including volatile and non-volatile memory and/or storage elements), at least one input device such as a keyboard, and at least one output device. Program code is applied to data entered using the input device or received from another source to perform the method described above and to generate output information. The output information is applied to one or more output devices such as a display screen of the computer, or to another application or computer.

In at least some cases, it is advantageous if each program is implemented in a high level procedural or object-oriented programming language such as VBA, Visual Basic, C, C++, Java, or Perl to communicate with a computer system. However, the programs can be implemented in assembly or machine language, if desired. In any case, the language may be a compiled or interpreted language.

In at least some cases, it is advantageous if each such computer program is stored on a storage medium or device, such as ROM or magnetic diskette, that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the following claims. For example, the solution software may be further integrated with other Office applications including Word, Outlook, and/or Access). One or more mobile telephone devices may serve as all or part of the presenter's server and/or the client computer. Other software may be used as a bridge between the solution software and the presentation software or the Web server.

Although the present invention has been described in terms of exemplary embodiments and alternatives, it will be appreciated that various modifications and alterations might be made by those skilled in the art without departing from the spirit and scope of the invention. The invention should, therefore, be measured in terms of the claims which follow.

What is claimed is:

1. A method for use in enhancing interactive presentations, comprising:
gaining access to a computer-based presentation that is presentable by conventional desktop presentation software;
adding a feature to the computer-based presentation, an aspect of the feature being presentable by the conventional desktop presentation software;
based on the feature, issuing a real-time directive to a playback device using Internet-standard protocols; and
using Internet-standard protocols, receiving a response to the directive.

2. The method of claim 1, further comprising:
in real time, altering the computer-based presentation based on the response.

3. The method of claim 1, wherein the conventional desktop presentation software includes at least a portion of Microsoft PowerPoint application software.

4. The method of claim 1, wherein the conventional desktop presentation software includes presentation software having an interface that is compatible with Microsoft Visual Basic.

5. The method of claim 1, further comprising:
communicating with the playback device via Web server software.

6. The method of claim 1, wherein adding a feature to the computer-based presentation includes adding a polling question to the presentation.

7. The method of claim 1, wherein receiving a response to the directive includes receiving an answer to a polling question.

8. The method of claim 1, further comprising:
using the conventional desktop presentation software to display poll results based on the response.

9. The method of claim 1, wherein the playback device runs Web browser software.

10. The method of claim 1, wherein the playback device includes at least a portion of a personal digital assistant (PDA) device.

11. The method of claim 1, wherein the playback device includes at least a portion of a wireless communications device.

12. The method of claim 1, wherein the directive includes data that is in a format that is compatible with Hypertext Markup Language.

13. A method for use in enhancing interactive presentations, comprising:
gaining access to a computer-based presentation that is presentable by conventional desktop presentation software;
adding a feature to the computer-based presentation;
based on the feature, issuing a real time directive to a playback device using Internet protocols;
using Internet protocols, receiving a response to the directive in real time; and
based at least in part on the response, providing a real time analysis of results of issuing the directive.

14. The method of claim 13, wherein the analysis of results includes an analytical graphical depiction of results of issuing the directive.

15. The method of claim 13, wherein the analysis of results includes a heat map graphical depiction of results of issuing the directive.

16. The method of claim 13, further comprising:
providing content to a spreadsheet based on the response.

17. The method of claim 13, further comprising:
providing content to a database based on the response.

18. The method of claim 13, wherein the analysis of results relies on an interface that is compatible with Microsoft Visual Basic.

19. The method of claim 13, wherein the response includes a polling response.

20. A system for use in enhancing interactive presentations, comprising:
an access mechanism that gains access to a computer-based presentation that is presentable by conventional desktop presentation software;
a feature addition mechanism that adds a feature to the computer-based presentation, an aspect of the feature being presentable by the conventional desktop presentation software;
a directive issuing mechanism that, based on the feature, issues a real-time directive to a playback device using Internet-standard protocols; and
a response receiving mechanism that, using Internet-standard protocols, receives a response to the directive.

21. A system for use in enhancing interactive presentations, comprising:
an access mechanism that gains access to a computer-based presentation that is presentable by conventional desktop presentation software;
a feature addition mechanism that adds a feature to the computer-based presentation;
a directive issuing mechanism that, based on the feature, issues a real time directive to a playback device using Internet protocols;
a response receiving mechanism that, using Internet-standard protocols, receives a response to the directive in real time; and
an analysis providing mechanism that, based at least in part on the response, provides a real time analysis of results of issuing the directive.

22. Computer software, residing on a computer-readable storage medium, comprising a set of instructions for use in a computer system to help cause the computer system to enhance interactive presentations, the set of instructions for causing the computer system to:
gain access to a computer-based presentation that is presentable by conventional desktop presentation software;
add a feature to the computer-based presentation, an aspect of the feature being presentable by the conventional desktop presentation software;
based on the feature, issue a real-time directive to a playback device using Internet-standard protocols; and
using Internet-standard protocols, receive a response to the directive.

23. Computer software, residing on a computer-readable storage medium, comprising a set of instructions for use in a computer system to help cause the computer system to enhance interactive presentations, the set of instructions for causing the computer system to:
gain access to a computer-based presentation that is presentable by conventional desktop presentation software;
add a feature to the computer-based presentation;
based on the feature, issue a real time directive to a playback device using Internet protocols;
using Internet protocols, receive a response to the directive in real time; and
based at least in part on the response, provide a real time analysis of results of issuing the directive.
